(19) United States
(12) Patent Application Publication
(10) Pub. No.: US 2026/0017556 A1
(43) Pub. Date: Jan. 15, 2026

(54) QUANTUM ERROR CORRECTION SYSTEM AND PROCESS FOR QUANTUM ERROR CORRECTION

(71) Applicant: OKINAWA INSTITUTE OF SCIENCE AND TECHNOLOGY SCHOOL CORPORATION, Kunigami-gun Okinawa (JP)

(72) Inventors: Jason TWAMLEY, Kunigami-gun, Okinawa (JP); Isaac Fernando QUIJANDRIA DIAZ, Kunigami-gun, Okinawa (JP); Anshuman NAYAK, Kunigami-gun, Okinawa (JP)

(73) Assignee: OKINAWA INSTITUTE OF SCIENCE AND TECHNOLOGY SCHOOL CORPORATION, Kunigami-gun Okinawa (JP)

(21) Appl. No.: 19/101,328

(22) PCT Filed: Aug. 7, 2023
(86) PCT No.: PCT/JP2023/028833

§ 371 Date: Feb. 5, 2025

Related U.S. Application Data
(60) Provisional application No. 63/395,552, filed on Aug. 5, 2022.

(51) Int. Cl. G06N 10/70

(52) U.S. Cl. CPC G06N 10/70

(57) ABSTRACT

A quantum error correction system that can realize a scheme which, when the quantum system suffers some noise, the quantum system itself can act on itself to correct itself against this noise is provided. The quantum error correction system includes a quantum material and a bi-chromatic recovery drive generator in communication with the quantum material. The bi-chromatic recovery drive generator sends a waveform to the quantum material.

### TECHNICAL FIELD

The present invention relates to a quantum error correction system and a process for quantum error correction.

### BACKGROUND ART

Quantum information is very fragile and can be destroyed by virtually any noise that affects the quantum computer or quantum device. One of the key discoveries that showed the world that quantum computers could be possibly built was the invention of Quantum Error Correction techniques described in NPTL 1. Following this ground-breaking discovery, the race to build a quantum computer began and nowadays there are nation-states, multinational and start-up companies attempting to build quantum computers. The goal is to build a fault tolerant quantum computer using millions of qubits—a fault tolerant quantum computer is where the error correction itself has errors but the entire machine, base quantum computer and faulty error correction, can still operate in a manner which performs useful quantum computations. There has been a LOT of research into quantum error correction, designing new codes, designing methods to remove noise from quantum bits using complex control pulse sequences, or continuous driving, etc. If one can design cleaner qubits (physical systems with lower amounts of noise), then the task of performing Quantum Error Correction (QEC) and Fault Tolerant QEC (FT QEC) becomes easier and easier. To design and build cleaner qubits is both a very technology related question, i.e. designing purer materials, designing almost identical quantum bits etc., but there are ways to drive dirty individual qubits to improve them towards cleaner individual qubits.

Decoherence is one of the primary obstacles that must be overcome in the development of all quantum technologies. Researchers, over the past 30 years have developed a variety of techniques to protect quantum information from noise. Recently, NPTL2 showed a scheme to overcome static inhomogeneous broadening in a spin ensemble.

### CITATION LIST

### Non Patent Literature

NPTL1: W. Shor, Peter (1995). “Scheme for reducing decoherence in quantum computer memory”. Physical Review A. 52 (4): R2493-R2496. Bibcode: 1995PhRvA.52.2493S. doi:10.1103/PhysRevA.52.R2493. PMID 9912632
NPTL2: R. Finkelstein et al., Phys. Rev. X 11, 011008 (2021)

### SUMMARY

The protocols used to perform cleaning on an individual qubit, however, involve the application of long sequences of pulses (known as Dynamical Decoupling—DD for short), or continuous driving by electromagnetic radiation (Continuous Dynamical Decoupling—CDD for short). DD is a complex technique and CDD produces a qubit which is often not very handy for experiments. Both techniques fail if one attempts to apply them to a collection of qubits where each qubit has small variations as the pulses/controls which operate correctly on one qubit won't work correctly on another qubit which has some small variation in its parameters.

These small variations in the design of individual qubits are also a problem in quantum computers. Even if one builds a quantum computer with a collection of clean qubits, but where each qubit is slightly different, this too can ruin the operation of a quantum computer and thus all current quantum computer designs have an enormous amount of hardware associated with the tuning of each and every qubit so that they can be practically identical.

It would be helpful to provide a quantum error correction system and a process for quantum error correction that can realize a scheme which, when the quantum system suffers some noise, the quantum system itself can act on itself to correct itself against this noise.

A quantum error correction system according to several embodiments includes: a quantum material; and a bi-chromatic recovery drive generator in communication with the quantum material, wherein the bi-chromatic recovery drive generator sends a waveform to the quantum material.

A process for quantum error correction according to several embodiments includes sending a bi-chromatic electromagnetic drive to a quantum system including an ensemble of non-interacting multi-level spins.

According to the present disclosure, a quantum error correction system and a process for quantum error correction that can realize a scheme which, when the quantum system suffers some noise, the quantum system itself can act on itself to correct itself against this noise can be provided.

The scheme can accomplish much more and can effectively clean-up, many forms of noise, both static and temporal. The scheme can take either a single or ensemble of dirty spin systems, and produce a clean spin system, where unwanted static and dynamic variations are greatly suppressed via the application of two suitable off-resonant drives. As an example, the present disclosure mainly shows how this auto-correction scheme can be applied to nuclear spins coupled to Nitrogen-Vacancy spins in diamond, and shows, through extensive numerical simulations, how the inhomogencous dephasing in an ensemble of nuclear spins coupled to Nitrogen-Vacancy (NV) centers, as well as the self-dephasing of a single nuclear spin coupled to a single NV center, can be mitigated continuously in a realistic experiment by using light shifts. The simplicity of this scheme will aid in the preparation and stabilizing of highly coherent, homogeneous spin ensembles, or individual spins, for use in many quantum technologies such as quantum computing, quantum memories, quantum repeaters and quantum sensors.

### BRIEF DESCRIPTION OF DRAWINGS

FIG. 1 is a block diagram illustrating the configuration of the quantum error correction system according to one embodiment.

FIG. 2 is a flowchart for explaining an example of the operation of the quantum error correction system in FIG. 1.

FIG. 3 is a first diagram for explaining an example of the operation of the quantum error correction system in FIG. 1.

FIG. 4 is a first graph diagram for explaining an example of the operation of the quantum error correction system in FIG. 1.

FIG. 5 is a second diagram for explaining an example of the operation of the quantum error correction system in FIG. 1.

FIG. 6 is a second graph diagram for explaining an example of the operation of the quantum error correction system in FIG. 1.

FIG. 7 is a third graph diagram for explaining an example of the operation of the quantum error correction system in FIG. 1.

FIG. 8 is a third diagram for explaining an example of the operation of the quantum error correction system in FIG. 1.

FIG. 9 is a fourth graph diagram for explaining an example of the operation of the quantum error correction system in FIG. 1.

### DESCRIPTION OF EMBODIMENTS

### Introduction

There remain formidable challenges to be overcome in the quest to build a large-scale quantum information processing device beyond the noisy intermediate scale quantum (NISQ) devices era [1]. One major challenge is the construction of physical qubits which have error rates far below the threshold required for Fault Tolerant Quantum Error Correction [2]. Another challenge is to fabricate identical qubits so that quantum technologies need not include a plethora of additional control circuitry to tune each and every qubit [3]. For quantum devices using spins-in-solids, which covers applications in quantum memories [4-7], quantum repeaters [8], quantum sensors [9], and quantum computers [10], the fabrication, and/or, the design of control schemes, to deliver arrays of identical spins which possess extremely low decoherence rates remains a very tough problem.

The present disclosure considers that realistic spins/qubits are really multilevel quantum systems, possessing more than two quantum levels each, where each level experiences the noise. The present disclosure shows that by arranging for simple off-resonant continuous wave (CW) driving in this multi-level structure one can engineer dynamics which automatically corrects for any dephasing noise in an ensemble or an individual spin. This corrects for dephasing arising from a spatial distribution of spins with inhomogeneous energy splittings, and it also, corrects for time varying noise on individual or collective energy splitting of the spins. Moreover, the present disclosure shows that this auto-correction is fault tolerant and corrects for amplitude noise present in the correction drive fields themselves. This automatic self-correction scheme thus takes an ensemble of dirty-spins and creates an ensemble of near-identical and long-lived coherent qubits which can then be used for any purpose in quantum machines.

### Cleaning Up Dirty Qubits

To clean-up or decrease the effects of dephasing due to spatial inhomogeneity in an ensemble or due to temporal fluctuations in qubit energies, researchers have developed a wide range of techniques. To correct temporal dephasing one can utilize quantum error correction (QEC) but this requires significant additional abilities e.g. encoding a logical qubit into several physical qubits and the ability to perform fast readout or reset of qubits. QEC however can operate even when the noise is Markovian. In many realistic cases dephasing noise is colored or non-Markovian and researchers have developed three primary methods to ameliorate the effects of such colored dephasing baths from qubits. These can be classed as (A) discrete dynamical decoupling (DDD) pulsed control inspired by the Hahn echo sequence [11], (B) continuous dynamical decoupling (CDD) control which uses CW drives, and (C) decoherence free subspaces [12]. Before describing the auto-correction protocol, first, comment on these existing cleaning protocols is provided.

Firstly, DDD methods require complicated pulse sequences and typically involve the application of π-pulses. If there is significant inhomogeneity in the qubit resonance frequencies then the application of perfect π-pulses is not possible and the DDD control weakens unless one employs sophisticated pulse shaping techniques [13]. However, despite their complexity researchers have demonstrated that DDD can protect single as well as ensembles of spins from the environment [4, 14-16].

The continuous limit of DDD sequences, that is, when the number of pulses goes to infinity and the time delay in between them goes to zero was first considered in the seminal works [17, 18]. To the best of our knowledge, the idea of CDD or the use of CW drives to minimize the effects of decoherence, was introduced in Ref. [19]. Nevertheless, this work dealt with the protection of unitary operations or gates from the environment. The authors in Ref. [20] introduced and demonstrated a CDD scheme to protect a diamond qubit (NV center) from both, environmental and control drive fluctuations. Protection against the environment was achieved via a strong drive on resonance with the energy splitting of the qubit. On the other hand, protection against fluctuations in the drive strength was achieved via a sequence of orthogonal drives of decreasing intensity. This scheme is referred to as concatenated continuous dynamical decoupling (CCDD) and has been employed for sensing [21] and extended to deal with ensembles of NV centers [22]. The downside of this method is that the protected qubit has an energy splitting several orders of magnitude smaller than the original qubit which results in slower gates and therefore, its operation can be limited by the qubit relaxation time. Alternatively, by dressing a three-level system (NV center ground state) with two CW drives on resonance with a pair of transitions, it is possible to engineer a qubit protected from the environmental noise up to first order in the ratio between the inhomogeneity strength and the Rabi frequency of the drives [23, 24]. A so-called mixed dynamical decoupling (MDD) scheme has also been introduced which incorporates both discrete and continuous dynamical decoupling [25].

The quantum error correction system according to one embodiment utilize an approach which is completely different from the above methods wherein one uses light shifts, or the shifts in the energy levels of a multilevel system due to off-resonant drives, in order for the system to automatically compensate for unwanted energy fluctuations. These methods were originally devised to deal with Doppler broadening in atomic gases but can also be generalized to other inhomogeneous systems [26-29].

Below the present disclosure shows how the Doppler broadening-based scheme, which was originally devised to counter spatial inhomogeneities, can be expanded to also counter temporal noise. This scheme can take either an ensemble (or an individual spin), and produce a homogeneous ensemble (or an individual spin), with greatly improved coherence. The present disclosure shows how the scheme can be implemented in a spin associated with color centers in diamond as set forth below in order to protect ensemble as well as single spin coherence.

### Configuration

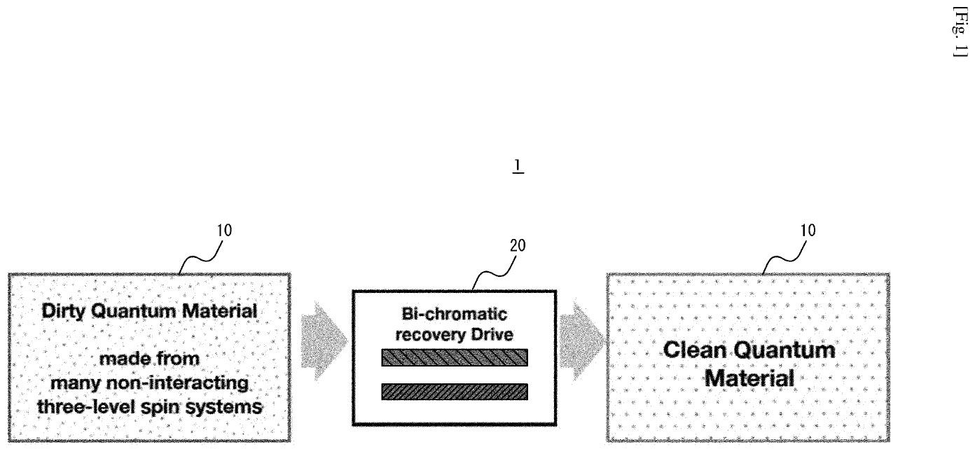

FIG. 1 is a block diagram illustrating the configuration of the quantum error correction system 1 according to one embodiment. As shown in FIG. 1, the quantum error correction system 1 may include a quantum material 10 and a bi-chromatic recovery drive generator 20 in communication with the quantum material 10. In the present disclosure, the term “quantum error correction” is used in a broad sense to include not only quantum error correction in the strict sense of the term but also quantum error suppression and quantum error mitigation.

Any quantum system interacts with its environment. This interaction leads to dissipation and decoherence. Quantum error correction, quantum error suppression and quantum error mitigation are strategies to counteract the effects of the environment. Quantum error correction and quantum error suppression are quantum control schemes. Quantum error correction identifies and fixes errors. In essence, it can be regarded as a form of quantum feedback control implemented on a redundant physical system. Redundancy is fundamental so that checks which reveal the presence of an error can be made. Quantum error suppression comprises a set of techniques which reduces the likelihood of an error at the hardware level (redundancy is not required for this). DD falls under this category. DD can be regarded as an open-loop control technique in which, by means of a series of pulses, the system is effectively decoupled from its environment. Finally, quantum error mitigation is a post-processing technique in which the output from ensembles of quantum circuits is used to minimize the effects of the environment on averages of measured quantities.

The quantum material 10 may include a spin associated with color centers in diamond. In the present disclosure, “the spin associated with color centers in diamond” includes a nuclear spin coupled to NV spins in diamond or a NV spin in diamond. The quantum material 10 may include a single or an ensemble of non-interacting multilevel spins which are qubits. The spins may be the spins associated with color centers in diamond. The quantum material 10 may include at least one of: an individual or an ensemble of non-interacting multi-level quantum systems, a quantum memory, a quantum repeater, a quantum sensor, an individual or ensemble of defects in diamond, and a quantum computer. The quantum material 10 may be influenced by noise fluctuating in time.

Each of the spins may have at least three states |1>, |2> and |3> associated with respective energy levels E1, E2, and E3, wherein E1<E2, and E2<E3, and wherein the spins undergo energy shifts due to noise such that when state 12> of one of the spins undergoes an energy shift of −δ, state |3> of the same spin undergoes an energy shift of −sδ, wherein s is real, and s>0. s is greater than 4, preferably greater than 6 and more preferably greater than 10. The energy levels may be anharmonic. The noise may be either static spatially inhomogencous noise, or spatially homogenous or inhomogencous temporal noise, preferably spatially homogenous or inhomogeneous temporal noise. The spins may be under the influence of temporal noise.

The bi-chromatic recovery drive generator 20 may include a laser source and an optical system which guides light irradiated from the laser source to the quantum material 10. The bi-chromatic recovery drive generator 20 may send a waveform of the light to the quantum material 10. The waveform may be either at an optical or microwave frequency. The waveform may include two tones of continuous electromagnetic fields of identical or nearly identical amplitude Ω, having frequencies of ω+Δ and ω−Δ, wherein ω corresponds to the energy separation between the states |2> and |3> and wherein Δ is the frequency detuning and Δ>0. The two tones of continuous electromagnetic fields may be in phase or nearly in phase. The tones may have frequencies which are oppositely detuned from an auxiliary transition. The waveform may be an off-resonant continuous wave driving in the multi-level structure.

(Ω/Δ)² may be equal to or nearly equal to 1/s in the limit when s>1, typically s>4, and more typically s>10, even more typically s>>1. In the quantum error correction system 1, 0.5Δ/sqrt(s)<Ω<1.5Δ/sqrt(s), more preferably 0.9Δ/sqrt(s)<Ω<1.1Δ/sqrt(s), more preferably 0.99Δ/sqrt(s)<Ω<1.01Δ/sqrt(s), even more preferably 0.999Δ/sqrt(s)<Ω<1.001Δ/sqrt(s).

The quantum error correction system 1 serves as an automatic quantum error correction system that includes the bi-chromatic recovery drive generator 20 that converts an ensemble of dirty qubits and creates an ensemble of near-identical and long-lived coherent qubits. In the automatic quantum error correction system, the bi-chromatic recovery drive generator 20 may shift the energy levels of the multilevel system due to off-resonant drives in order for the qubit system to automatically compensate for unwanted energy fluctuations.

The waveform from the bi-chromatic recovery drive generator 20 may be an electromagnetic field that exerts a light shift to automatically correct for fluctuating unknown energy shifts acting on the dirty qubit. The dirty qubit may be at least one of a plurality of dirty qubits and the waveform may remove dephasing noise from each qubit of the at least one of the plurality of dirty qubits. The waveform may correct for static noise, temporal noise, or phase noise. The waveform may eliminate the inhomogeneous dephasing of the ensemble of non-interacting multi-level spins. The waveform may convert the dirty qubit into a clean qubit. The waveform may homogenize a group of at least one of the plurality of dirty qubits and at least one of a plurality of clean qubits. The resulting clean qubit may be protected from both spatial and temporal energy fluctuations.

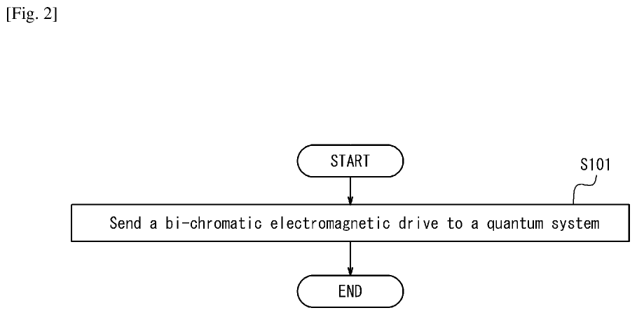

FIG. 2 is a flowchart for explaining an example of the operation of the quantum error correction system 1 in FIG. 1. The process according to one embodiment, performed using the quantum error correction system 1 illustrated in FIG. 1, is described with reference to FIG. 2.

In step S101, the quantum error correction system 1 performs sending, by the bi-chromatic recovery drive generator 20, a bi-chromatic electromagnetic drive to a quantum system of the quantum material 10 comprising the ensemble of non-interacting multi-level spins.

In addition to the step S101, the process may further include assessing the power spectrum (including the frequency and the strength) of the noise, typically the temporal noise. The process may further include tuning the bi-chromatic electromagnetic drive based on the power spectrum of the noise. The process may further include determining Ω and/or Δ based on the power spectrum of the noise. In this case, the quantum error correction system 1 may further include an assessment system to assess the temporal noise of the quantum material 10. The waveform of the bi-chromatic recovery drive generator 20 may be tuned based on the assessment of the temporal noise to correct error associated with the temporal noise of the quantum material 10.

### Light Shifts

As briefly mentioned above, to achieve automatic self-correction the quantum error correction system 1 needs the atomic system to un-do any variations in its own energy level structure. This un-doing will be achieved by the quantum atom-optical process known as the light shift. By light shift the present disclosure refers to the shift in the energy levels of a two-level system (TLS) due to its continuous driving with an off-resonant classical field. These energy shifts are also referred to as ac-Stark shifts. The present disclosure sticks to the former nomenclature. In the following, the present disclosure will give a brief derivation of them.

Consider a TLS {|1 [symbol] , |2═} with bare Hamiltonian (hereinafter, set ℏ=1)

$${H}_{TLS} = ω2 \vert 2 〉 〈 2 \vert , \qquad ( 1 )$$

where ω₂ corresponds to the TLS energy splitting and where the present disclosure has assumed the energy of the ground state |1 [symbol] to be identical to zero. The present disclosure now considers a transversal drive

$${H}_{drive} ( t ) = 2 Ω cos ( {ω}_{d} t + ϕ ) ( \vert 1 〉 〈 2 \vert + H . c ) \qquad ( 2 )$$

with amplitude Ω, frequency ω_{d} and phase ϕ. From now on the present disclosure will restrict to the phase ϕ=0. Thus, the total Hamiltonian of the driven TLS reads

$$H ( t ) = {H}_{TLS} + {H}_{drive} ( t ) . \qquad ( 3 )$$

In a frame rotating with the drive frequency and in the rotating wave approximation (RWA), the latter Hamiltonian can be simplified to

$${H}_{RWA} = Δ \vert 2 〉 〈 2 \vert + Ω ( \vert 1 〉 〈 2 \vert + H . c . ) \qquad ( 4 )$$

with Δ=ω₂−ω_{d} the detuning between the qubit and the drive. The RWA is valid as long as ω₂>>Ω. The eigenenergies of Hamiltonian (4) are

$${E}_{\pm } = \frac{1}{2} ( Δ \pm \sqrt{{Δ}^{2} + 4 {Ω}^{2}} ) . \qquad ( 5 )$$

In the far-detuned limit (|Δ|>>Ψ) the drive barely dresses the energy levels. Then, the eigenenergies correspond to the bare energies E₁ and E₂ (corresponding to Ω=0) plus a small correction. Up to second order in the ratio (2/|4| the eigenenergies are given by

$${E}_{+} \approx {E}_{2} + \frac{{Ω}^{2}}{\vert Δ \vert} \qquad ( 6 )$$

$${E}_{-} \approx {E}_{1} - \frac{{Ω}^{2}}{\vert Δ \vert} , \qquad ( 7 )$$

where the present disclosure considers E₂>E₁. The actual value of these depends on the sign of the detuning. For Δ>0, E₁=0 is the ground state energy and E₂=Δ, while for Δ<0 the ground state energy becomes E₁=A and E₂=0. It is the small corrections ±Ω²/(4|Δ|), referring to as light shifts. The present disclosure will show below how these light shifts can be used to un-do any additional shifts in the energy level structure of a multi-level system.

The present disclosure first will consider an inhomogeneous spin ensemble with no temporal noise and show how the auto-correction can clean up inhomogeneous dephasing. The present disclosure then will consider a single spin with temporal noise and show that the auto-correction can also clean up non-Markovian temporal noise.

Continuous Off-Resonance Protection from Inhomogeneous Dephasing Using Light Shifts

Inhomogeneous dephasing, or the relative loss of quantum coherence of an ensemble of emitters due to their inhomogeneous properties, is ubiquitous in solid state applications. Common sources of inhomogeneous dephasing are the Doppler effect in gases, spatial variations in the local environments of emitters in crystals as well as the lack of reproducibility in artificial atoms [30].

The idea to compensate the inhomogeneous Doppler dephasing using light shifts was first introduced in Ref. [26]. This idea was extended later in Ref. to deal with systems close to their ground state. More recently, a very related work provided a more rigorous mathematical treatment including the effects of higher-order corrections as well as considering the case of driving fields near resonance [29].

The above methods are not restricted to spin ensembles. As the present disclosure will show later in this section, they can also find application in situations where a single spin interacts with a slowly fluctuating bath. Treating the spins as multi-level systems, the goal here is to generate an ensemble, or a single TLS or qubit protected from the inhomogeneity. The present disclosure will start by reviewing the methods in Refs. [27, 29].

### A. Spin Ensemble Correction

Here the present disclosure is going to restrict to the case of non-interacting spins. Theoretically, inhomogeneous dephasing can be modelled as a spin ensemble with a static statistical distribution of resonance frequencies for the individual spins in the ensemble. This statistical distribution of frequencies limits the collective manipulation of the spins and ultimately leads to the decay of the coherent oscillations in a Ramsey-type experiment as the individual spins in an initial coherent superposition will precess with different frequencies. Therefore, different types of inhomogeneous systems can be described within the same formalism.

Let us start by considering each spin as a TLS. Neglecting their interaction, each of them is described by the Hamiltonian Hᵢ=(ω₂+δᵢ)|2 [symbol] 2|, with ω₂ the homogeneous frequency of the ensemble, i.e., the frequency of all the spins in the absence of any inhomogeneity. On the other hand, δᵢ is a random frequency drawn from a probability distribution which characterizes the spectral distribution of the spin ensemble. From Eqs. (6) and (7), it is straightforward to show that in the presence of the inhomogeneity the light shifts become ±Ω²/4(Δ+δᵢ). Assuming that |Δ|>>δᵢ, that is, that the drive is far detuned from all the TLS in the ensemble, the latter reduces to ±(Ω²/4Δ)(1−δᵢ/Δ)=±(Ω²/4Δ)∓δᵢ(Ω/Δ)² up to first order in the small ratio δᵢ/Δ. While this reveals that light shifts indeed become sensitive to the inhomogeneity, the inhomogeneity-dependent corrections to both levels will cancel each other and the TLS frequency will be shifted independently of it.

The authors in Ref. [27] demonstrated that it is indeed possible to obtain a total nonzero inhomogeneity-dependent light shift by introducing auxiliary levels which are also susceptible to the same source of inhomogeneity. For the rest of the discussion, the present disclosure is going to focus on the scheme in Ref. [29] that makes use of a single auxiliary level.

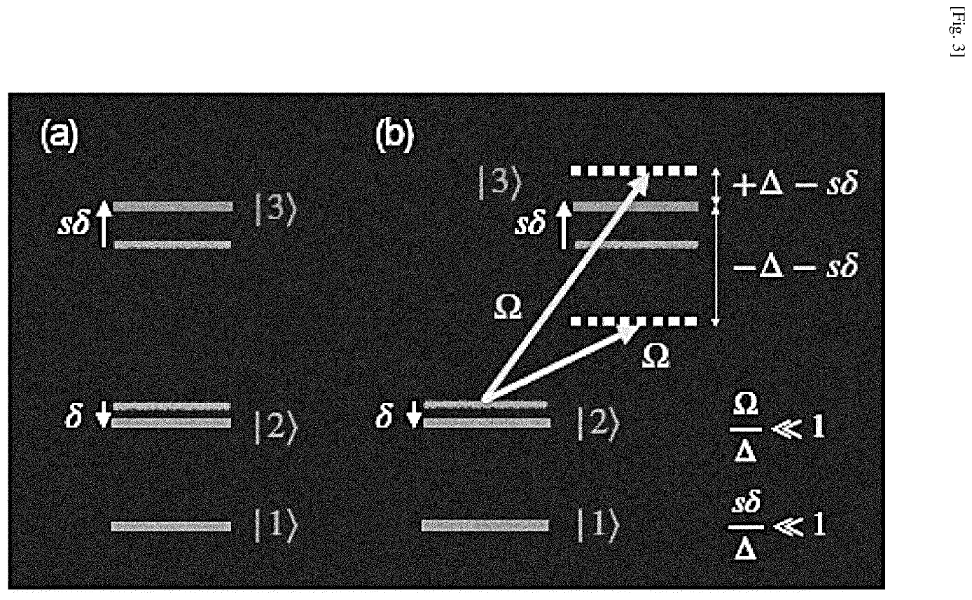

FIG. 3 is a first diagram for explaining an example of the operation of the quantum error correction system 1 in FIG. 1. FIG. 3 shows continuous protection scheme using light shifts. (a) shows three level system {|1 [symbol] , |2 [symbol] , |3 [symbol] }. The lower two levels {|1 [symbol] , |2 [symbol] } comprise the qubit to protect from the inhomogeneous dephasing δ. For this, the quantum error correction system 1 uses the third sensor quantum level |3 [symbol] which is s times more sensitive to the inhomogeneity/noise, (b) by continually applying two drive electromagnetic fields which are off-resonant.

Let us consider now the three-level system {l1 [symbol] , |2 [symbol] , |3 [symbol] } in (a) of FIG. 3. The levels |1 [symbol] and |2 [symbol] comprise the TLS to protect from the environment. while the level |3 [symbol] is an auxiliary level with frequency ω₃. The present disclosure will now consider two driving fields with the same amplitude Ω and opposite detunings ±Δ (for Δ>0) from the transition between the |2 [symbol] and |3 [symbol] levels. In a doubly-rotating frame with frequencies ω₂ and ω₃, the total Hamiltonian of the system is given by H₂₃(t)=Hᵢₙₕ+H_{drive}(t) with

$${H}_{inh} = - {δ}_{i} \vert 2 〉 〈 2 \vert + s {δ}_{i} \vert 3 〉 〈 3 \vert , \qquad ( 8 )$$

the inhomogeneous Hamiltonian and

$${H}_{drive} ( t ) = \frac{Ω}{\sqrt{2}} ( \vert 2 〉 〈 3 \vert {e}^{+ i Δ t} + H . c . ) + \frac{Ω}{\sqrt{2}} ( \vert 2 〉 〈 3 \vert {e}^{- i Δ t} + H . c . ) , \qquad ( 9 )$$

the Hamiltonian of the drives in the RWA (ω₂, ω₃>Ω). Notice that the present disclosure has introduced the scaling parameter s>0 and that, by definition, the inhomogeneous frequency shift in level |3 [symbol] is −s times that of level |2 [symbol] . This is depicted in (b) of FIG. 3. Treating the two drives independently and considering the energy hierarchy Δ>>Ω, sδᵢ, the total light shift correction to level |2 [symbol] is given by

$$\begin{matrix}{E}_{light} & \approx & - \frac{{Ω}^{2}}{2 ( Δ + s {δ}_{i} )} + \frac{{Ω}^{2}}{2 ( Δ - s {δ}_{i} )} & ( 10 ) \\ & = & - \frac{{Ω}^{2}}{2 Δ} + \frac{1}{2} {( \frac{Ω}{Δ} )}^{2} s {δ}_{t} + \frac{{Ω}^{2}}{2 Δ} + \frac{1}{2} {( \frac{Ω}{Δ} )}^{2} s {δ}_{i} & ( 11 ) \\ & = & {( \frac{Ω}{Δ} )}^{2} s {δ}_{i} . & ( 12 )\end{matrix}$$

In other words, the effective Hamiltonian of the TLS becomes H_{eff,i}≈(−δᵢ+E_{light})|2 [symbol] 2|. In the large off-resonance regime Ψ/Δ<<1, an auxiliary level very sensitive to the inhomogeneity, i.e., s>>1 allows to compensate for the inhomogeneous shift by setting (Ω/Δ)²=1/s so that −δᵢ+E_{light}≈0. The present disclosure stresses that this is an approximated result as there are higher order corrections to the light shift.

### Single Spin Correction

In the previous section, the present disclosure showed how light shifts can be used to correct the inhomogeneous dephasing in a spin ensemble. Alternatively, the quantum error correction system 1 could use them to correct the dephasing of a single spin that results from a distribution of acquired phases in repeated measurements over time. The origin of this distribution are slowly fluctuating environments such as weakly interacting nuclear spins.

Similar to the previous subsection, a doubly driven single spin is described by a Hamiltonian of the form H₂₃(t)=Hᵢₙₕ(t)+H_{drive}(t). with H_{drive}(t) given by Eq. (9). The difference with the previous case is that the inhomogeneous Hamiltonian is now time-dependent: Hᵢₙₕ(t)=−δ(t)|2 [symbol] [symbol] 2|+sδ(t)|3 [symbol] 3|, with δ(t) characterizing the slow noise. Nevertheless, the perturbative approach leading to Eq. (10) still holds if δ(t) evolves on a time scale r much larger than that of the driving field. In other words, whenever τ>>1/Δ. Equivalently, the bandwidth of the noise BW˜1/τ needs to be much smaller than the detuning Δ. Notice that the above discussion rules out the validity of this method to deal with Markovian or memoryless environments as these relax instantaneously (τ=0) to their equilibrium state.

In order to illustrate the validity of the light shift method for fluctuating environments, the present disclosure is going to consider two canonical examples of noise in solid state systems: random telegraph noise (RTN) and Ornstein-Uhlenbeck (OU) noise.

### A. Random Telegraph Noise (RTN)

First, the present disclosure will consider a TLS with time-dependent noise in its energy splitting modelled by random telegraph noise (RTN). This model describes low-frequency fluctuations in microwave qubits and resonators [31, 32] and has also been implemented via the modulation of a flux qubit in order to study the phenomenon of motional narrowing in a superconducting circuit [33]. Starting point of the present disclosure is the Hamiltonian in the laboratory frame

$$H ( t ) = [ {ω}_{2} + {δ}_{RTN} ( t ) ] \vert 2 〉 〈 2 \vert , \qquad ( 13 )$$

with ω₂ the qubit frequency and δ_{RTN} the RTN amplitude. In this case the amplitude changes randomly between the frequency values ±ξ with jump rate χ. The probability of n jumps in a time interval t is given by Pₙ(t)=(χt)ⁿe^{-χt}/n!. In addition, in order to probe the response of the TLS the present disclosure will consider a weak transversal probe H_{drive}(t)=g cos(ωt)(|1 [symbol] 2|+H.c.) with g<<<ω₂, as well as the transversal relaxation of the TLS described by the Markovian master equation δₜ [symbol] =−i[H(t)+H_{probe}(t), [symbol] ]+(γ/2) [symbol] [|1 [symbol] [symbol] 2] [symbol] , with [symbol] [O] [symbol] =2O [symbol] O^{†}−O⁵⁵⁴ O [symbol] − [symbol] O^{†}O.

### B. Ornstein-Uhlenbeck (OU) Noise

As a second example the present disclosure will consider the case of Ornstein-Uhlenbeck (OU) noise [34]. This corresponds to a Gaussian stochastic process which models accurately the effects of a spin bath on a central spin such as an NV center in diamond. In this case, the fluctuations in the NV center frequency are a consequence of the fluctuations in the effective magnetic field experienced by it which in turn are a consequence of the reorientation of the spins in the bath due to their mutual magnetic dipole-dipole interactions.

The effects of a slowly fluctuating spin bath on the central spin coherence are studied in two NMR-inspired type of experiments: free induction decay (FID) or simply, the free evolution of the central spin, and Hahn echo (HE) refocusing pulse sequence. In the first case, the central spin is initialized in its ground state |1 [symbol] and subsequently, by means of a π/2 pulse (instantaneous) is prepared in a coherent superposition of its ground and excited states lying on the equator of the Bloch sphere, i.e., |ψ(0) [symbol] =|1 [symbol] +|2 [symbol] (omitting the normalization factor). This superposition will acquire a random relative phase o after a free evolution time r due to the influence of the fluctuating spin bath, i.e., |ψ(τ) [symbol] =|1 [symbol] +e^{iϕ}|2 [symbol] . This relative phase can be mapped into a population difference in a Ramsey-type experiment in which the measurement signal oscillates with a frequency proportional to ϕ. Even though the effective field is quasi-static throughout a measurement, its magnitude may vary over several realizations of the same duration t due to the slow drift of the spins in the bath. Therefore, when averaging a large number of oscillations of different frequency, a decaying envelope due to the lack of coherence between them is observed. This decaying envelope can be understood as the dephasing of the central spin with itself due to the randomly acquired phases.

The HE refocusing technique allows to lift the decoherence due to the slowly fluctuating spin bath. Similarly to the FID, the spin is initialized on the equator of the Bloch sphere and it is left to evolve freely for a time t after which it acquires a relative phase o due to the slow field: |ψ(τ) [symbol] =|1 [symbol] +e^{iϕ}|2 [symbol] . Now, a π-pulse is applied in order to effectively time-revert the spin dynamics, i.e., the ground state is now ahead in phase: |ψ(τ) [symbol] =e^{iϕ}|1 [symbol] +|2 [symbol] . Finally, the spin is let to evolve again for a time t after which both ground and excited states will catch up in phase |ψ(2τ) [symbol] =|1 [symbol] +|2 [symbol] thus effectively decoupling the spin from the effects of its environment. This holds regardless of the different values of the effective field in different experiments. Therefore, this pulse sequence allows to extend the coherence time of the central spin, however, it is limited by the correlation time of the spins in the bath. Whenever their fluctuations are no longer negligible it is not possible to time-revert their effects.

There are extensions of the HE refocusing technique such as the Carr-Purcell-Meiboom-Gill (CPMG) pulse sequence in which more x pulses are included as well as periods of free evolution of different duration [35, 36]. In fact, it has been shown in [15] for an optimized pulsed sequence that in the limit of an infinite number of pulses, the coherence time of an NV center is proportional to the number of pulses. The latter time being only limited by the relaxation of the NV center.

In a numerical simulation, the present disclosure can mimic the effects of the spin bath on a central spin via the time-dependent Hamiltonian H(t)=[ω₂+δ_{eff}(t)]|2 [symbol] 2| where the random effective field δ_{eff} is given by

$${δ}_{eff} ( t ) = {δ}_{r} + {δ}_{OU} ( t ) . \qquad ( 14 )$$

Here, δᵣ is a random field drawn from a Gaussian distribution which is constant in every simulation but varies from one to another. On the other hand, δₒᵤ(t) is a OU process with zero mean and correlation function [symbol] δ_{OU}(t)δ_{OU}(0) [symbol] =b² exp(−t/τ_{c}), with b the variance of the coupling strengths of the central spin to the spins in the bath, and r. the correlation time [21]. Therefore, the static component δᵣ models the FID, while the OU process δₒᵤ(t) the influence of the spin bath correlations in the central spin dynamics.
Combability of the Scheme with Single-Qubit Gates

Whereas the ability to extend the coherence lifetime of a quantum system is desirable, the quantum error correction system 1 also manipulates this system while protecting it from the environment. For this reason, in this section the present disclosure will investigate if the discussed protection scheme is compatible with the application of coherent gates. Here, the present disclosure will restrict to the case of single-qubit gates. As examples, the present disclosure will consider a π-pulse U_{X}_{_{π}} and a Hadamard gate U_{H}. Denoting a general rotation by an angle of θ around the A axis of the Bloch sphere by R_{A}(θ)=exp(−iθA/2), the latter gates correspond to U_{X}_{_{π}}=R_{X}(π) and U_{H}=R_{X}(π)R_{Y}(π/2). For this analysis, the present disclosure will consider a TLS in a slowly fluctuating environment described by RTN fluctuations of its transition frequency and the present disclosure will neglect energy relaxation.

The present disclosure applies these gates via coherent pulses on the TLS and for simplicity the present disclosure considers square pulses. A general rotation R_{A}(θ) will correspond to a pulse of the form H_{drive}(t)=ΩA[Θ(t−t₀)−Θ(t−t_{f})], with Ω the Rabi frequency of the drive, Θ(t) the Heaviside function, to and of the times at which the pulse is turned on and turned off respectively, and where the desired rotation angle is the pulse area, i.e., θ=Ωt_{drive}, with t_{drive}=t_{f}−t₀ the duration of the pulse. The present disclosure evaluates the fidelity of the gate derived from these pulses in the presence of noise with and without continuous protection by simulating quantum process tomography (QPT) [42].

A quantum process is mathematically represented by a completely positive linear map ε. The goal of QPT is to estimate ε from experimental measurements. A quantum process acting on an arbitrary quantum state ρ can be cast in the Kraus representation

$$ε ( ρ ) = {\sum }_{k} {E}_{k} ρ {E}_{k}^{†} \qquad ( 16 )$$

with Eₖ the so-called Kraus operators. The present disclosure can choose an arbitrary operator basis {\tilde{E}ₖ} in which to represent the Kraus operators, i.e., Eₖ=Σᵢeₖᵢ\tilde{E}ᵢ. For the case of a single TLS a natural choice is the Pauli basis {I, X, Y, Z} which are adopted here. Therefore, the above relation can be re-written as

$$ε ( ρ ) = {\sum }_{ij} {χ}_{ij} {\tilde{E}}_{i} ρ {\tilde{E}}_{j}^{†} , \qquad ( 17 )$$

with

$${χ}_{ij} = {\sum }_{k} {e}_{ki} {e}_{kj}^{*}$$

the so-called process of chi-matrix. Once the operator basis is chosen, the process matrix completely characterizes the process. In order to numerically determine the chi-matrix, the present disclosure prepares the set of initial states {|1 [symbol] , |2 [symbol] , (|1 [symbol] +|2 [symbol] )/\sqrt{2}, (|1 [symbol] +i|2 [symbol] )/\sqrt{2}}. Each of these initial states is subject to the combined action of the pulses, RTN and correction drives. The corresponding output states are reconstructed via quantum state tomography upon gathering a considerable large measurement statistics, in the present disclosure's case 10⁴ independent measurements for each of the above states. Finally, the chi-matrix is obtained by solving equation (17).

### Description of the Diamond Electron-Nuclear Spin System

The present disclosure considers a diamond sample containing NV defects which are hyperfine coupled to nearby ¹³C nuclear spins. NV defects are perhaps the only example of a room temperature qubit and researchers are investigating them for use in quantum memories, quantum interconnects and quantum computers. Such systems have been intensively studied, and researchers have found ways to use the NV electrons to polarize and control a large collection of individual neighboring ¹³C nuclear spins. The hyperfine coupling to nearby ¹³C nuclear spins can be strong and can range from 1.3 MHz to 130 MHz [43]. Nuclear spins in diamond, particularly ¹³C, couple more weakly to their environment than electronic spins and therefore usually have much longer coherence times [43, 45]. The present disclosure will now study the coupled NV electron spin S, and ¹³C nuclear spin I, system.

The present disclosure considers applying a static magnetic field of magnitude B₀ along the NV axis, which defines the z-direction. The Hamiltonian for the combined electron-nuclear spin system under the secular approximation can be written as:

$${H}_{s} / ℏ = D {S}_{z}^{2} + {γ}_{e} {B}_{0} {S}_{z} - {γ}_{c} {B}_{0} {I}_{z} + A {S}_{z} {I}_{z} , \qquad ( 18 )$$

where S_{z} is the NV spin-1 matrix along the z (quantization) direction with eigenstates |mₛ [symbol] and eigenvalues mₛ=0, ±1. Similarly, I_{z} is the ¹³C nuclear spin-½ matrix along z, with eigenstates |m_{I} [symbol] and eigenvalues m_{I}=±½. In addition, D/2π=2.87 GHz is the zero-field splitting, γₑ/2π=28 GHz/T is the gyromagnetic ratio of the NV center, γ_{c}/2π=10.7 MHz/T is the gyromagnetic ratio of the ¹³C and A is the hyperfine coupling strength. Here, the present disclosure assumes a relatively strong coupling of A/2π˜13 MHz [46]. Due to the hyperfine interaction, the electronic transitions become nuclear spin dependent and the same is the case for the nuclear transitions which now depend on the electronic spin state. The present disclosure denotes the eigenstates of the interacting electronic and nuclear spin system |mₛ, m_{I} [symbol] =|mₛ [symbol] ⊗|m_{I} [symbol] . The only transitions allowed between the different energy levels are those satisfying the selection rules: Δmₛ=0 and Δm_{I}=±1, or Δmₛ=±1 and Δm_{I}=0 [47]. The external field B₀ lifts the degeneracy of the magnetic levels mₛ=±1. For the present disclosure's purposes, from now on the present disclosure is going to restrict to only two levels of the NV center mₛ=0 and mₛ=−1.

### A. Type of Noise for Both the Electron and Nuclear

For the sake of simplicity, let us first focus on a single ¹³C nuclear and NV electron spin pair. Considering the ¹³C nuclear spin to be in close proximity to the electron spin, they will both experience the same environment comprised by nearby weakly interacting nuclear spins in the sample hosting them. By virtue of its larger gyromagnetic ratio, i.e., γₑ/γ_{c}˜3000, the electron spin interacts more strongly with the magnetic field Bᵣ(t) created by the slowly fluctuating nearby spins. This is key for the implementation of the protection protocol as it implies that electronic transitions are more sensitive to the environment than the nuclear ones.

Neglecting the coherent exchange of excitations between the electron and nuclear spins with the environmental spins, the present disclosure arrives to a phase randomization model in which the environment induces random fluctuations in the NV center and the nuclear spin transition frequencies which in turn leads to the loss of their quantum coherence. This is described by the Hamiltonian

$$H / ℏ = [ {ω}_{I} - {δω}_{I} ( t ) ] {I}_{z} + [ {ω}_{s} + δ {ω}_{s} ( t ) ] {σ}_{z} + A {σ}_{z} {I}_{z} , \qquad ( 19 )$$

where σ_{z} is the Pauli-z spin ½ operator which results from restricting to only two NV center energy levels, ω_{I}=−γ_{c}B₀ and ωₛ=D+γₑB₀ are the unperturbed nuclear and NV electron spin frequencies respectively, and δω_{I}(t)=γ_{c}Bᵣ(t) and δωₛ(t)=γₑBᵣ(t) are the electron and nuclear spin frequency fluctuations (respectively) due to the environment which the present disclosure treats as classical stochastic processes.

Let us consider now an ensemble of ¹³C nuclear-NV electron spin pairs. The local environments experienced by these are not homogeneous throughout the sample. Therefore, the frequency fluctuations experienced by each individual pair will depend on its particular location. This can be modelled as a sum of non-interacting Hamiltonians

$$H / ℏ = {\sum }_{j} [ {ω}_{I} - {δω}_{I}^{j} ( t ) ] {I}_{z}^{j} + [ {ω}_{s} + {δω}_{s}^{j} ( t ) ] {σ}_{z}^{j} + A {σ}_{z}^{j} {I}_{z}^{j} ,$$

where the index j labels the different pairs and therefore, the frequency fluctuations

$${ω}_{I}^{j} ( t ) and {ω}_{s}^{j} ( t )$$

are pair-dependent. Thus, this model describes both spatial as well as temporal fluctuations. In most solid-state systems, position-dependent fluctuations are described using normally distributed random variables, while time-dependent fluctuations are described using the Ornstein-Uhlenbeck process, i.e., a stochastic Gaussian process with a finite correlation time.

### Description of the Autonomous Protection Protocol

### A. Brief Overview

The coherence protection protocol the present disclosure will summarize here belongs to the class of continuous dynamical decoupling methods. Its goal is to protect a transition between two energy levels—what the present disclosure will refer to as the qubit or two-level system (TLS) transition from environment-induced fluctuations which ultimately lead to the loss of quantum coherence. In order to achieve the purpose, the present disclosure will make use of a secondary transition between one of the qubit levels and a third auxiliary level. This auxiliary energy level is also affected by the same source of noise, nevertheless, it is more sensitive to it than the qubit transition, i.e., the magnitude of the frequency change as a result of a small fluctuation in the environment configuration is much larger for the auxiliary level (with respect to the ground state) than for the qubit transition.

It is well-known that the off-resonance driving of an energy transition leads to a small shift in its frequency also known as Stark or light shift. As the present disclosure will detail below, by simultaneously driving the qubit and the auxiliary transitions red and blue far off-resonance, the quantum error correction system 1 can produce a Stark shift on the qubit transition which, by carefully choosing the driving fields' amplitudes and detunings, can exactly compensate for the environment induced frequency fluctuations. This is only possible due to the larger sensitivity to the noise of the auxiliary energy level.

As the present disclosure will show later, all of the above requirements are fulfilled by the ¹³C nuclear spin and an electronic spin in a NV defect both hosted in a diamond sample. Due to its larger gyromagnetic ratio which in turns leads to a higher sensitivity to magnetic noise, it is possible to use the electronic transition to protect the nuclear spin from the magnetic noise induced decoherence. In the following subsection, the present disclosure will introduce the mathematical details of the protection scheme for an arbitrary multilevel quantum system.

### B. General Scheme

Consider the three-level system {|0 [symbol] , |1 [symbol] , |2 [symbol] }. The levels |0 [symbol] and |1 [symbol] comprise the qubit, while |2 [symbol] is an auxiliary energy level. Taking the energy of the ground state as a zero energy reference, the Hamiltonian of the three-level system in the presence of the environment is given by (hereinafter, set ℏ=1)

$${H}_{0} / ℏ = ( {ω}_{1} - δ ) \vert 1 〉 〈 1 \vert + ( {ω}_{2} + sδ ) \vert 2 〉 〈 2 \vert , \qquad ( 20 )$$

with ω₁ the qubit transition energy, ω₂ the energy of the auxiliary level, δ is a random number drawn from a distribution of width σ which describes the noise induced frequency shifts. Finally, s is the so-called sensitivity, i.e., the ratio between the variations with respect to fluctuations in the environment of the auxiliary and the qubit transition energies. Here, the present disclosure considers that the sensitivity is independent of the noise induced frequency fluctuations.

Now, the present disclosure introduces two CW drives which couple the energy levels |1 [symbol] and |2 [symbol] . Both drives have the same Rabi frequency Ω and are red and blue detuned from the transition between the two levels

$${H}_{drive} ( t ) / ℏ = Ω \{ cos [ ( {ω}_{2} - {ω}_{1} - Δ ) t ] + cos [ ( {ω}_{2} - {ω}_{1} + Δ ) t ] \} ( \vert 1 〉 〈 2 \vert + h . c . ) \qquad ( 21 )$$

where Δ>0 is the detuning. As shown in Refs. [44, 29], the total Stark shift of the qubit transition frequency due to the two driving fields in the far off-resonance limit (Δ>Ω, sσ) is

$${E}_{qubit}^{Stark} \approx - \frac{{Ω}^{2}}{2 ( Δ + s δ )} + \frac{{Ω}^{2}}{2 ( Δ - s δ )} \qquad ( 22 )$$

$$\approx {( \frac{Ω}{Δ} )}^{2} s δ , \qquad ( 23 )$$

which is proportional to the frequency fluctuation δ. Therefore, the total qubit Hamiltonian becomes

$${H}_{qubit} \approx \{ {ω}_{1} - [ 1 - {( \frac{Ω}{Δ} )}^{2} s ] δ \} \vert 1 〉 〈 1 \vert . \qquad ( 24 )$$

The term in the square brackets is proportional to δ and it can be eliminated by setting (Ω/Δ)²=1/s. These results correspond to the s [symbol] [symbol] 1 limit relevant for the present disclosure's upcoming discussion. A more general treatment for an arbitrary value of the sensitivity s can be found in the Appendix of Ref. [29].

### C. Detailed Application of Scheme to NV-¹³C System

The present disclosure will consider the system of a ¹³C nuclear spin coupled to a NV center via the hyperfine interaction and described by the Hamiltonian (19). Following the selection rules, the present disclosure will choose the nuclear transition |mₛ=−1, m_{I}=−½)↔|mₛ=−1, m_{I}=+½ [symbol] as the qubit transition |0 [symbol] ↔|1 [symbol] . On the other hand, the electronic transition |mₛ=−1, m_{I}=+½ [symbol] ↔mₛ=0, m_{I}=+½) will serve as the auxiliary transition |1 [symbol] ↔|2 [symbol] .

The goal is to protect the qubit transition from the magnetic noise due to the environment using the above introduced protection protocol. This is possible to do because of the larger gyromagnetic ratio of the electron which makes electronic transitions more sensitive to magnetic noise in comparison to nuclear transitions. In fact, in Eq. (19), the frequency fluctuations of both transitions are not independent

$$\vert {δω}_{s} ( t ) \vert = \frac{{γ}_{e}}{{γ}_{s}} \vert {δω}_{I} ( t ) \vert , \qquad ( 25 )$$

but they are related by the ratio of the respective gyromagnetic ratios. The present disclosure will call the above ratio the sensitivity s. Alternatively, it can be defined as the ratio between the fluctuations in the electronic ωₛ and nuclear (qubit) ω_{I} transition frequencies due to the magnetic noise along the z axis Bᵣ, i.e.,

$$s ≡ \vert \frac{d {ω}_{s} / {dB}_{r}}{d {ω}_{I} / {dB}_{r}} \vert = \frac{{γ}_{e}}{{γ}_{s}} . \qquad ( 26 )$$

For our chosen system, the above expression simplifies to

$$s = \frac{{γ}_{e}}{{γ}_{s}} = \frac{28 GHz}{10.705 MHz} \approx 2 615.6 \qquad ( 27 )$$

Therefore, in order to satisfy the protection condition, the present disclosure needs to set the ratio between the Rabi frequency of the drives and their detuning to: Ω/Δ=1/\sqrt{s}≈0.02. In the following section, the present disclosure will numerically simulate the protection of an ensemble of ¹³C nuclear spins, each individually coupled to a nearby NV center, using realistic experimental parameters.

### Simulation of the Protection Protocol to ¹³C Nuclear Spins in Diamond

The present disclosure now describes the simulation of the protection of an ensemble of 1000 ¹³C nuclear spins each of which is hyperfine-coupled to a nearby NV center. In addition, the present disclosure is going to neglect interactions between different nuclear-electron spin pairs. This noninteraction assumption will limit the concentration of NVs in the diamond to be preferably less than 1 ppm [48]. In order to simulate the time-dependent frequency fluctuations, the present disclosure will use the Ornstein-Uhlenbeck (OU) process. In particular, the present disclosure will implement the algorithm developed in Ref. [49]. The OU process is characterized by the two-time correlation function

$$〈 δω ( t ) δ ω ( 0 ) 〉 = {b}^{2} exp ( - t / τ ) . \qquad ( 28 )$$

This is defined in turn by two parameters, the effective coupling strength to the environment b, and r the correlation time of the environment. In terms of these, the present disclosure can calculate the free (induction) decay time

$${T}_{2}^{*} = \sqrt{2} b , i . e . ,$$

the characteristic decay time of a two-level system initially prepared in a superposition state averaged over a large number of realizations, as well as the Hahn echo (HE) decay time T_{HE}=(3τ/b²)^{1/3}. The present disclosure considers the following parameter values

$${T}_{2}^{*} = 10 ms , \text{?} = 0.5 s$$

$$\text{?} \text{indicates text missing or illegible when filed}$$

which corresponds to the standard deviation of magnetic noise b=141.4 Hz and correlation time of noise τ=10³ s. The value of coherence times chosen are very typical of what has usually been reported for ¹³C spins [50].

The present disclosure performs the simulations in the co-rotating frame of NV and ¹³C, therefore the present disclosure can ignore the Larmor precessions due to the magnetic field B₀ and A. Nevertheless, experiments should be performed in the moderate to low field regime of 200-500 G in order to obtain a relatively large Zeeman splitting for the electronic transition. This permits to drive the system off-resonance without the risk of addressing a higher energy level.

In the simulations, to measure the coherence time, a simple Ramsey measurement on the spin qubit is performed. The qubit is initialized in the equal superposition of |0 [symbol] and |1 [symbol] . Then the present disclosure lets it evolve under the noise process and the protection drive scheme for some time t. The present disclosure then projects it back to the basis state and measure the expectation value of σ_{z}, and repeat the process for various time intervals 1. Consequently, in the simulations, the present disclosure defines coherence as [symbol] σ_{z}(t) [symbol] , normalized to 1.

The present disclosure described a concrete application of the general autonomous-protection scheme which some of us previously developed [44]. The present disclosure describes in detail how to enhance the nuclear spin coherence of a ¹³C which has hyperfine coupling to the electronic system of a nearby NV defect. The correction scheme can operate identically on an individual NV-¹³C pair or on an ensemble of pairs. The protection protocol should be relatively insensitive to the precise value of the hyperfine coupling A_{zz}, and thus the protection should operate even if the ¹³C is not in the first coordination shell of the NV. Based on the simulations, for any physical system of coupled nuclear-electron spins which can be described by Eq. (18), (with or without the ZFS term), one should be able to apply the autonomous-protection scheme to extend the nuclear spin coherence time. Such electron-nuclear spin systems are the focus of numerous implementations of quantum information holding technologies, such as in SiV defects in diamond [53, 54], nuclear spins in donors in Silicon [55-57], or in Silicon Carbide [58], to mention a few examples. The protection protocol is expected to be applicable to such nuclear-electronic spin systems when 1) the primary noise is magnetic noise, 2) the Zeeman shifts of all the energy levels must be linear in the magnetic field, and 3) the transition selection rules between the levels must allow one to off-resonantly strongly drive the protection transitions. Since the application of the autonomous-protection involves the application of CW drives between the upper state of the TLS (|1 [symbol] ), and the sensor state (|2 [symbol] ), all coherent quantum operations on the TLS {|0 [symbol] , |1 [symbol] }, are unaffected and thus any quantum technology that involves nuclear spins can be improved through the application of the autonomous-protection protocol.

### Effect

The scheme described in the present disclosure is very robust and can take an individual dirty qubit (with a short T₂ time) and clean it (greatly reduce the dephasing noise from its local environment and can lengthen T₂). It can also operate on an ensemble of dirty qubits to remove dephasing noise from each qubit in the ensemble. This same control can also homogenize a collection of dirty (or clean), where each of these qubits possesses slightly different energies. Thus, this simple continuous drive can take a collection of dirty qubits—each prepared in a slightly different way and produce a collection of near-identical clean qubits without any complicated pulses, additional hardware or individual tuning or addressing of any of the qubits.

The present disclosure shows numerically that the methods introduced in Refs. [27, 29] to correct Doppler and thermal broadening in atomic ensembles can also suppress temporal fluctuations in the frequency of a single spin due to a slowly fluctuating environment. In particular, the present disclosure shows how this scheme can be implemented in a realistic experiment using the spins associated with color centers in diamond.

### Example 1

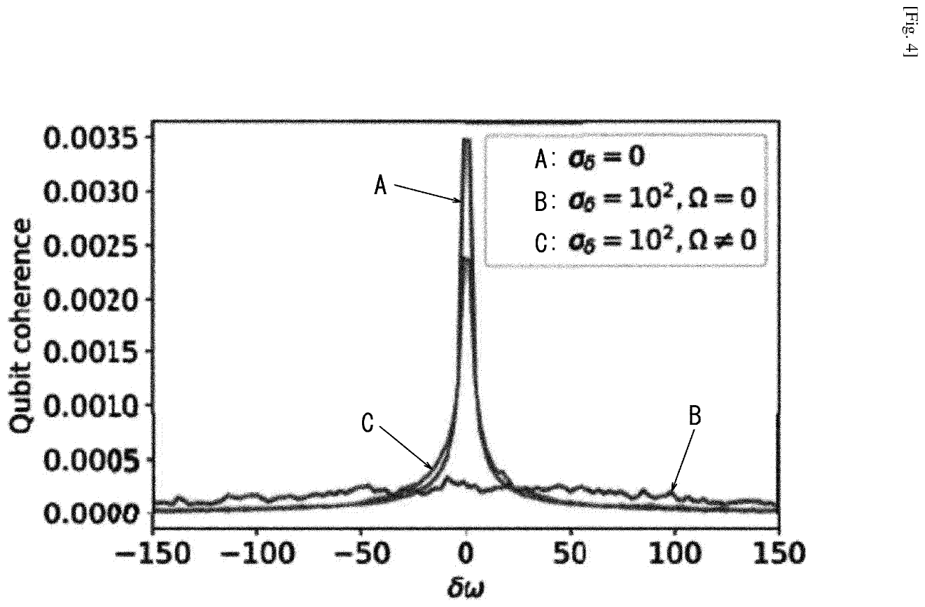

FIG. 4 is a first graph diagram for explaining an example of the operation of the quantum error correction system 1 in FIG. 1. FIG. 4 shows correction of the inhomogeneous dephasing for an ensemble of 500 atoms. Here, the present disclosure shows the average qubit coherence for (graph A) a single homogeneous qubit, (graph B) an ensemble of qubits with inhomogeneous dephasing given by a normal distribution, and (graph C) same as the before but under continuous protection using a pair of drives with opposite detuning from an auxiliary transition.

FIG. 4 shows comparison of the average response of an ensemble of 500 atoms with inhomogeneous dephasing modelled as random detunings drawn from a normal distribution with variance δ_{δ}=10² (in units of the qubit relaxation Y) without (graph B) and with (graph C) the above described continuous protection scheme using an auxiliary level with scaling factor s=10.

### Example 2

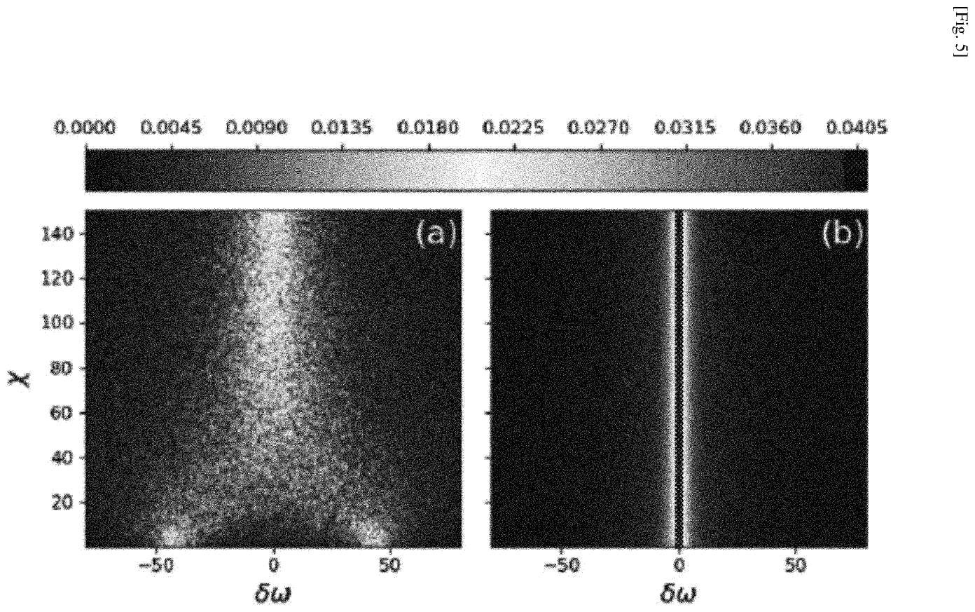

FIG. 5 is a second diagram for explaining an example of the operation of the quantum error correction system 1 in FIG. 1. FIG. 5 shows performance of the auto-correction scheme to clean up non-Markovian temporal noise on a single spin system: (a) Excited state probability for a two-level system subject to longitudinal Random Telegraph Noise (RTN) of amplitude ξ=43 as a function of the detuning δω of a weak probe from the qubit transition and the RTN rate χ. Without the auto-correction the TLS's coherence is poor when exposed to this type of noise. (b) Excited state probability when the auto-correction is applied, where two off-resonance transitions between the qubit excited state and a higher level s=10 times more sensitive to the RTN are simultaneously driven. The corresponding Rabi frequency and detuning magnitude are Ω=927 and |Δ|=3000 respectively. All parameters are given in units of the qubit relaxation rate γ. When the auto-correction is applied, the TLS's coherence properties are greatly improved and becomes essentially immune to the noise.

The response of the TLS [symbol] |1 [symbol] [symbol] 2| [symbol] as a function of the probe detuning δω=ω−ω₂ and the RTN jump rate χ is shown in (a) of FIG. 5 for a single realization of the noise. In the limit of a slow jump rate (χ<ξ). the TLS responds at both ω₂±ξ as it can be clearly seen from the two peaks at the bottom of the plot. On the other hand, in the fast jump limit (χ>>ξ), it is not possible to resolve the individual frequencies and only the response of the TLS at the average frequency ω₂(δω=0) is witnessed.

In order to refocus the TLS, the present disclosure now includes the third level which experiences an inhomogeneous frequency shift [ω₃−sδ_{RTN}]|3 [symbol] 3|. By coupling the levels |2 [symbol] and |3 [symbol] with two off-resonant drives below and above the corresponding transition energy ω₃−ω₂, (b) of FIG. 5 shows how it is possible to eliminate the inhomogeneous drift in frequency.

### Example 3

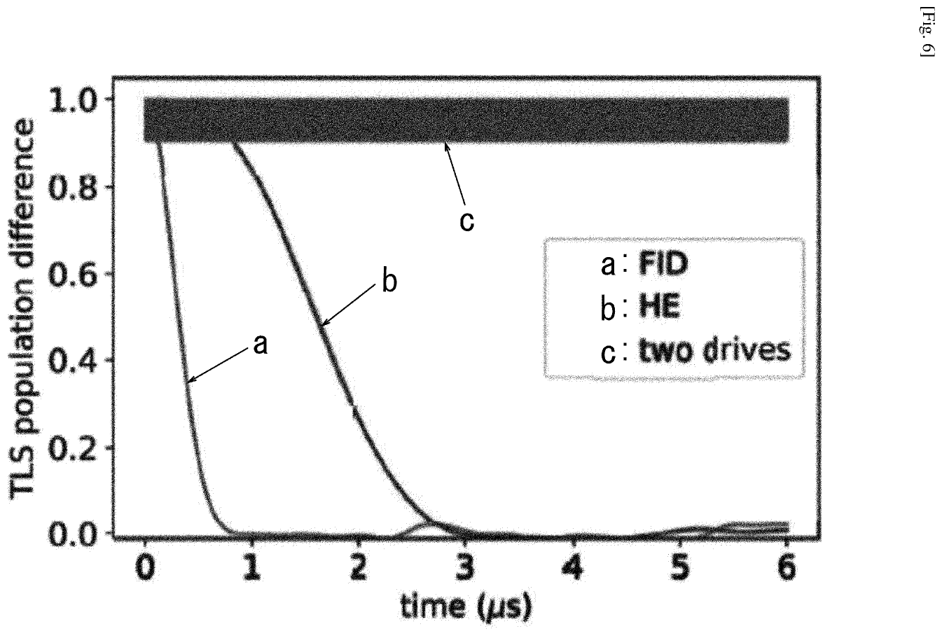

FIG. 6 is a second graph diagram for explaining an example of the operation of the quantum error correction system 1 in FIG. 1. FIG. 6 shows Ramsey-type experiment for a TLS under Ornstein-Uhlenbeck noise due to its interaction with a spin bath.

The decaying envelopes for the FID and HE are shown in FIG. 6 in graph a and graph b respectively. They have been simulated using the stochastic field (14) and correspond each to an average over 3000 realizations of the noise. The present disclosure have considered the slow bath limit (τ_{c}>>1/b) which faithfully describes NV center experiments [15, 37]. The chosen parameters for this simulation are b=3.6 μs⁻¹ and τ_{c}=23.7 μs [15]. In addition, the present disclosure has neglected the spin relaxation. Once again, considering an auxiliary level with s=10, here the present disclosure shows that the two drive scheme allows to decouple the spin from its environment thus allowing the initial coherence, measured by the population difference of the states {|1 [symbol] , |2 [symbol] } in a Ramsey experiment and shown in graph c, to be preserved far beyond the FID and HE decay times. The fast oscillations observed are a consequence of using off-resonant drives. It can be shown that increasing the value of s will reduce the amplitude of these oscillations further.

### Example 4

### Experimental Proposal Using NV Centers

Example 4 relates to a secondary example of the NV spins in diamond included in the spins associated with color centers in diamond. So far, the present disclosure has considered three-level systems in which the second and third levels experience opposite frequency shifts due to a static or time-dependent inhomogeneity. Furthermore, in the numerical simulations, the present disclosure has considered that the frequency shift in the third level is s=10 times larger than that in the second level. The authors in Refs. [29, 38, 39] show that it is indeed possible to find this type of configurations in ensembles of atoms suffering from Doppler broadening or motional dephasing. Beyond these examples, here the present disclosure explicitly shows how such large sensitivities to the inhomogeneity can be achieved in a magnetically sensitive system such as the Nitrogen-Vacancy (NV) center in diamond [40].

Following Ref. [41], the NV center ground-state Hamiltonian is given by

$${\hat{H}}_{N V} = D {\hat{S}}_{z}^{2} + {γ}_{e} \vec{B} \cdot \hat{S} + ε ( {\hat{S}}_{x}^{2} - {\hat{S}}_{y}^{2} ) , \qquad ( 15 )$$

where, for the sake of clarity, the present disclosure has introduced the hat (\hat{ }) notation to differentiate scalars from operators. Here, D=2.878 GHz is the NV center zero-field splitting, γₑ=28 GHz/T is the gyromagnetic ratio of the electron and \vec{B}=B\vec{n} is an externally applied static magnetic field with magnitude B and direction given by the unit vector \vec{n}={cos ϕ sin β, sin β sin ϕ, cos β} in spherical coordinates. Here, β corresponds to the angle between the magnetic field orientation and the symmetry axis of the NV center and @ is the azimuthal angle. The present disclosure has collected the spin-1 Pauli matrices Ŝᵢ in the operator vector Ŝ={Ŝₓ, Ŝ_{y}, Ŝ_{z}}. Finally, ε represents the local strain within the lattice. Typically, D>>ε and thus the strain can be safely ignored. From now on the present disclosure will consider ε=0.

The present disclosure denotes the eigenstates of Hamiltonian (15) {|1_{β} [symbol] , |2_{β} [symbol] , |3_{β} [symbol] } which correspond to a fixed orientation of the magnetic field \vec{B} defined by the angle β (in the absence of strain, the corresponding eigenenergies are independent of the azimuthal angle and for this reason the present disclosure disregards it). Let us first define the scaling parameter s in a quantitative way. Consider the following two transitions: |2_{β} [symbol] →|1_{β} [symbol] with energy ϵ₁ which the present disclosure will denote as the qubit transition, and |3_{β} [symbol] →|1_{β} [symbol] with energy ϵ₂ which will be our auxiliary transition. The sensitivity of each of these to the inhomogeneity, in this case fluctuations in the magnetic field, is defined by ∂ϵᵢ/∂B. The scaling parameter s will be defined as the absolute value of the ratio between the auxiliary and the qubit transitions s≡|∂_{B}ϵ₂/∂_{B}ϵ₁|.

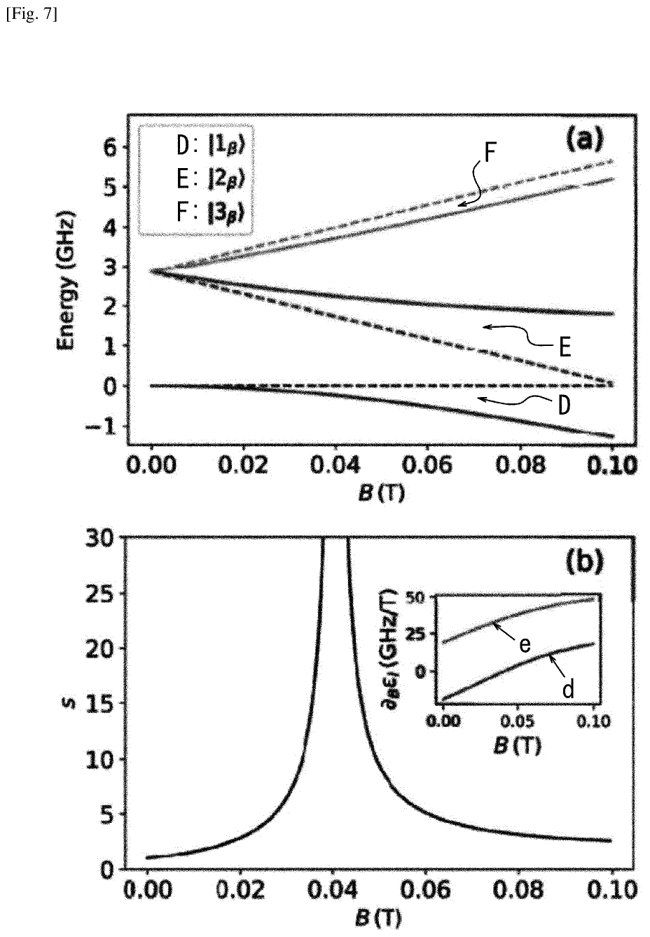

FIG. 7 is a third graph diagram for explaining an example of the operation of the quantum error correction system 1 in FIG. 1. (a) of FIG. 7 shows NV center eigenenergies for β=0 (dashed lines) and β=0.83 (solid lines) as a function of the magnetic field magnitude B. (b) ϵ₁ (graph d) and ϵ₂ (graph e).

In (a) of FIG. 7, the eigenenergies corresponding to a magnetic field aligned with the symmetry axis of the NV center, i.e., β=0 are plotted in dashed lines. In this case, the eigenstates correspond to those of the Ŝ_{z} operator, i.e., {|1_{β} [symbol] ≡|0 [symbol] , |2_{β} [symbol] ≡|−1 [symbol] , |3_{β} [symbol] ≡|+1)}, with Ŝ_{z}|0λ=0 and Ŝ_{z}|±1 [symbol] =±|±1 [symbol] . Here, δ₁=−γₑB and ϵ₂=+γₑB, and thus ∂_{B}ϵ₁=−γₑ, ∂_{B}ϵ₂=+γₑ and s=1. Apart from the fact that the scaling s cannot be increased, there is another caveat. For β=0, the |−1 [symbol] ↔|+1 [symbol] transition is forbidden as [symbol] ±1|H_{NV}|∓1 [symbol] =0.

In order to get an enhanced scaling and an allowed spin transition, the present disclosure can tilt the direction of \vec{B} away from the NV symmetry axis. As an example, the energy levels corresponding to β=0.83 rad are also shown in (a) of FIG. 7 in solid lines. This time all of the energy levels are sensitive to the magnitude of \vec{B}. (b) of FIG. 7 shows the scaling parameter as a function of the magnetic field magnitude B and as it can be seen, it can take very large values s≥10 in the region where B≈0.04 T. The inset of (b) of FIG. 7 shows the sensitivities ∂_{B}ϵᵢ as a function of B. The present disclosure can see that both increase with B and as ∂_{B}ϵ₁ changes sign from negative to positive around B≈0.04 T, their ratio becomes very large.

### Example 5

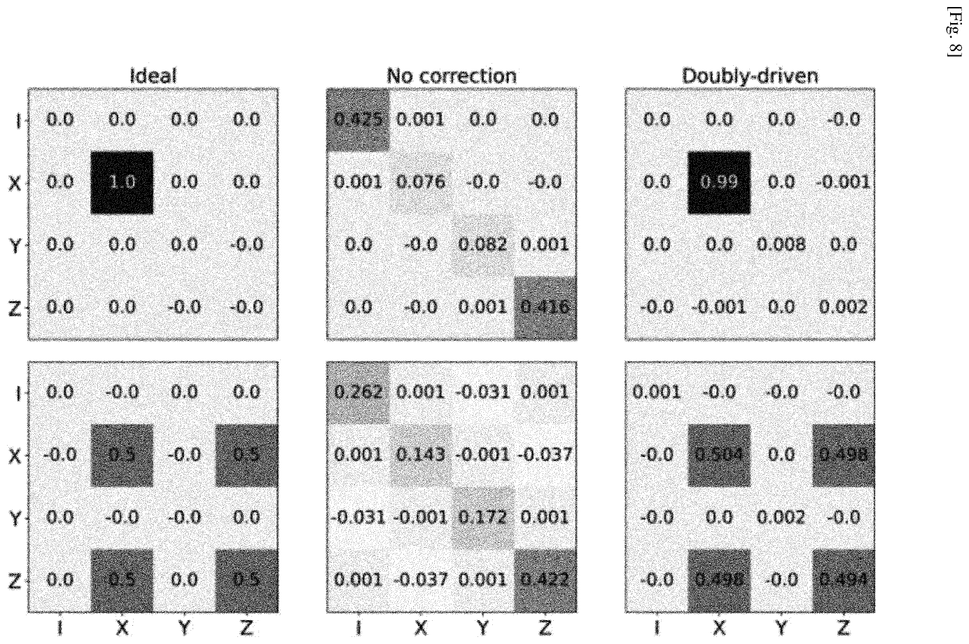

FIG. 8 is a third diagram for explaining an example of the operation of the quantum error correction system 1 in FIG. 1. FIG. 8 shows quantum process matrices for a X_{π}-pulse (top row) and a Hadamard gate (bottom row) in the presence of slow RTN with ξ=8/τ and χ=1/τ. For both processes the left column represents the ideal gate in the absence of noise, the middle column corresponds to the gate applied in the presence of the noise but without protection, and the right column represents the gate applied in the presence of the noise while simultaneously protecting the TLS with s=80 using the doubly-driven scheme with detuning Δ=4000/τ.

Scaling time in units of 1/τ, the correlation time of the environment, the reconstructed chi-matrix of the resulting gate process where the present disclosure has chosen: a RTN with amplitude ξ=8/τ, jump rate χ=1/τ, an emitter with sensitivity s=80 and drives' detuning Δ=4000/τ are shown in FIG. 8. The top row corresponds to U_{X}_{_{π}} and the bottom row to U_{H}. For both cases, the left column corresponds to the ideal process matrix, i.e., applying the pulses realizing the gates to the TLS in the absence of the RTN. The middle column corresponds to the process matrix when the pulses are applied in the presence of the RTN without the protection active. For the case of a slowly drifting environment, the gate pulses are mostly off-resonant with the TLS which results in rather low process fidelities F=0.08 for U_{X}_{_{π}} and F=0.25 for U_{H}. Finally, the right column corresponds to the gates realized through the pulses in the presence of the RTN and the doubly-driven protection scheme. It is straightforward to see that the ideal case process matrices are almost recovered. This is confirmed by the very high achieved process fidelity F=0.99 for both U_{X}_{_{π}} and U_{H}.

### Example 6

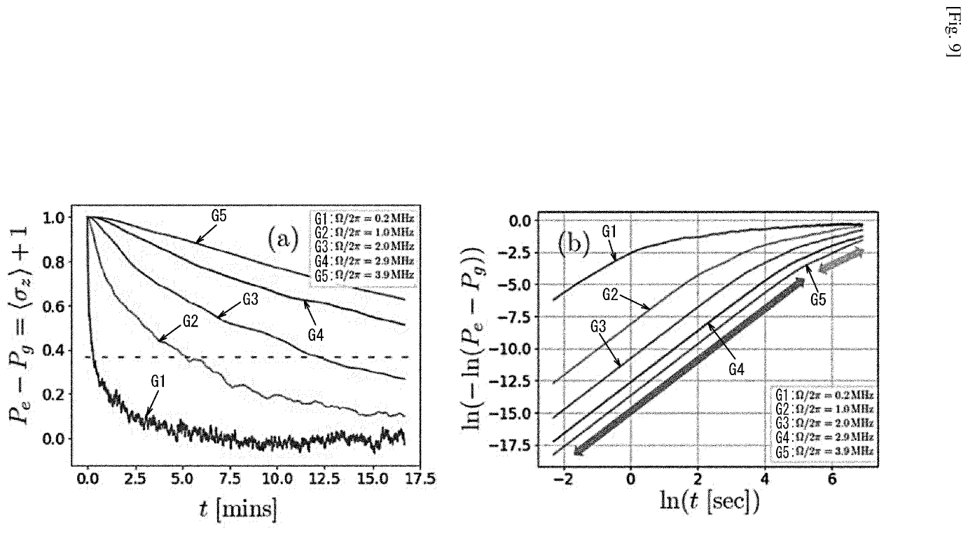

Example 6 relates to a main example of the nuclear spins coupled to NV spins in diamond included in the spins associated with color centers in diamond. FIG. 9 is a fourth graph diagram for explaining an example of the operation of the quantum error correction system 1 in FIG. 1. FIG. 9 shows extension of nuclear spin coherence under the autonomous-correction protocol—for different strengths of the protection drive. (a) of FIG. 9 shows time evolution of the nuclear ¹³C coherence for increasing strength of protection drive. Ω/2π=(0.2 . . . , 3.9) MHz. The dashed line valued at 1/e (=0.378), indicates the conventional value of fidelity where the system is said to have lost all its coherence. For low protection strengths the protection is minimal, while for high values protection extending beyond 17.5 minutes can be obtained. (b) of FIG. 9 shows the same as in (a) but on a log-log scale. All curves display an initial straight portion with a slope of 2 (long arrow portion), and then transition to another straight portion with a much lower slope (smaller arrow). From this, it can be inferred that the coherence decay happens over two timescales with an initial rapid decay of e^{-(t/T}^{ᵢₙᵢₜᵢₐₗ}⁾^{²} followed by a subsequent slow decay.

The present disclosure repeats this simulation for 1000 non-interacting ¹³C spins, each associated with an auxiliary NV electronic spin, and take an average. As seen in (a) of FIG. 9, on simulating the protocol via QuTiP version 4.7.0 [51]. it can be observed that the autonomous-correction protocol is able to extend the coherence time T₂ over

$${T}_{2}^{*}$$

and T_{HE}. Further, for a correction drive power of Ω/2π˜3.9 MHz (with an associated detuning Δ/2π˜200 MHz), the coherence time obtained is ˜2415 seconds (˜40 minutes), a 10⁵-fold enhancement over the natural

$${T}_{2}^{*} .$$

This is way beyond the record coherence time achieved for ¹³C of 90 seconds [52].

Further, it can be observed that for weaker drive fields, a nominal enhancement in T₂ is obtained and there are still fluctuations in the coherence curve, while for higher drives, the coherence curve is smooth and extends for longer duration. This is expected as the quality of protection provided by the scheme depends on how strongly detuned, the present disclosure is as compared to the noise experienced by the system: the stronger the Rabi drive Ω, the stronger the detuning Δ, and consequently the better is the protection. One key thing to note is that the simulations performed in the scheme are equivalent to taking a single qubit and doing multiple measurements, therefore the scheme naturally extends to the single qubit case.

Interestingly, it can be observed that under the protection scheme, the T₂ decay of the qubit happens on two timescales as seen in (b) of FIG. 9. The qubit experiences an initial rapid decay in the coherence at a rate e^{-(t/T}^{ᵢₙᵢₜᵢₐₗ}⁾^{²}, and then a much slower decay plateau. This transition happens at different time point for different drive strength, hinting that this might be a function of the protection field.

### Variation

Although the present disclosure has been described based on the drawings and examples, it should be noted that a person skilled in the art may easily make variations and modifications based on the present disclosure. Therefore, it should be noted that such variations and modifications are included within the scope of the present disclosure. For example, functions and the like included in each structure and step may be rearranged, and multiple structures and steps may be combined into one or divided, as long as no logical inconsistency results.

In the embodiment described above, the quantum material 10 is described as including a spin associated with color centers in diamond, but the quantum material 10 is not limited to this. The quantum material 10 may include any superconducting qubits such as fluxonium or blochnium as long as they display the desired features discussed herein.

The present disclosure may be implementable on many types of quantum hardware systems. Building arrays of identical clean quantum systems is not only useful for quantum computing but also for quantum memories, quantum repeaters (to build a quantum internet), and quantum sensors. The quantum error correction system 1 may be used for a quantum computer or any other devices.

Some embodiments of the present disclosure are exemplified below. However, it should be noted that embodiments of the present disclosure are not limited to the examples below.
[Appendix 1] A quantum error correction system comprising:
a quantum material; and
a bi-chromatic recovery drive generator in communication with the quantum material,
wherein the bi-chromatic recovery drive generator sends a waveform to the quantum material.
[Appendix 2] The quantum error correction system according to Appendix 1, wherein the quantum material comprises an ensemble of non-interacting multi-level spins.
[Appendix 3] The quantum error correction system according to Appendix 2, wherein each of the spins has at least three states |1>, |2> and |3> associated with respective energy levels E1, E2, and E3, wherein E1<E2, and E2<E3, and wherein the spins undergo energy shifts due to noise such that when state 12> of one of the spins undergoes an energy shift of −δ, state |3> of the same spin undergoes an energy shift of −sδ, wherein s is real, and s>0.
[Appendix 4] The quantum error correction system according to Appendix 3, wherein the waveform comprises two tones of continuous electromagnetic fields of identical or nearly identical amplitude Ω, having frequencies of ω+Δ and ω−Δ, wherein (corresponds to the energy separation between states |2> and |3>.
[Appendix 5] The quantum error correction system according to Appendix 4, wherein the two tones of continuous electromagnetic fields are in phase or nearly in phase.
[Appendix 6] The quantum error correction system according to Appendix 4, wherein (Ω/Δ)² is equal to or nearly equal to 1/s.
[Appendix 7] The quantum error correction system according to Appendix 3, wherein the noise is either static spatially inhomogeneous noise, or spatially homogenous or inhomogeneous temporal noise.
[Appendix 8] The quantum error correction system according to Appendix 2, wherein the waveform eliminates the inhomogeneous dephasing of the ensemble of non-interacting multi-level spins.
[Appendix 9] The quantum error correction system according to Appendix 1, wherein the waveform corrects for static noise, temporal noise, or phase noise.
[Appendix 10] The quantum error correction system according to Appendix 2, wherein the spins are qubits.
[Appendix 11] The quantum error correction system according to Appendix 1, wherein the waveform converts a dirty qubit into a clean qubit.
[Appendix 12] The quantum error correction system according to Appendix 1, wherein the waveform is an off-resonant continuous wave driving in a multi-level structure.
[Appendix 13] The quantum error correction system according to Appendix 11, wherein the dirty qubit is at least one of a plurality of dirty qubits, and the waveform removes dephasing noise from each qubit of the at least one of the plurality of dirty qubits.
[Appendix 14] The quantum error correction system according to Appendix 11, wherein the waveform homogenizes a group of at least one of a plurality of dirty qubits and at least one of a plurality of clean qubits.
[Appendix 15] The quantum error correction system according to Appendix 1, wherein the quantum material includes at least one of: an individual or an ensemble of non-interacting multi-level quantum systems, a quantum memory, a quantum repeater, a quantum sensor, an individual or ensemble of defects in diamond, an individual or ensemble of multi-level superconducting quantum systems, and a quantum computer.
[Appendix 16] The quantum error correction system according to Appendix 1, wherein the waveform is two tones of continuous electromagnetic fields of nearly identical amplitude, and are nearly in phase, and wherein the tones have frequencies which are oppositely detuned from an auxiliary transition.
[Appendix 17] The quantum error correction system according to Appendix 1, wherein the waveform is either at an optical or microwave frequency.
[Appendix 18] The quantum error correction system according to Appendix 11, wherein the waveform is an electromagnetic field that exerts a light shift to automatically correct for fluctuating unknown energy shifts acting on a dirty qubit, wherein the resulting clean qubit is protected from both spatial and temporal energy fluctuations.
[Appendix 19] An automatic quantum error correction system that comprises a bi-chromatic recovery drive that converts an ensemble of dirty qubits and creates an ensemble of near-identical and long-lived coherent qubits.
[Appendix 20] An automatic quantum error correction system that comprises a bi-chromatic recovery drive that shifts the energy levels of a multilevel system due to off-resonant drives in order for a qubit system to automatically compensate for unwanted energy fluctuations.
[Appendix 21] A process for quantum error correction, comprising sending a bi-chromatic electromagnetic drive to a quantum system comprising an ensemble of non-interacting multi-level spins.
[Appendix 22] The process according to Appendix 21, wherein each of the spins has at least three states |1>, |2> and |3> associated with respective energy levels E1, E2, and E3, wherein E1<E2, and E2<E3, and wherein the spins undergo energy shifts due to noise such that when state |2> of one of the spins undergoes an energy shift of −δ, state |3> of the same spin undergoes an energy shift of −sδ, wherein s is real, and s>0.
[Appendix 23] The process according to Appendix 22, wherein s is greater than 4, preferably greater than 6 and more preferably greater than 10.
[Appendix 24] The process according to Appendix 22, wherein the bi-chromatic electromagnetic drive comprises two tones of continuous electromagnetic fields of identical or nearly identical amplitude Ω, having frequencies of ω+Δ and ω−Δ, wherein (corresponds to the energy separation between states |2> and |3> and wherein Δ>0.
[Appendix 25] The process according to Appendix 24, wherein the two tones of continuous electromagnetic fields are in phrase or nearly in phase.
[Appendix 26] The process according to Appendix 24, wherein (Ω/Δ)² is equal to or nearly equal to 1/s.
[Appendix 27] The process according to Appendix 22, wherein the noise is either static spatially inhomogeneous noise, or spatially homogenous or inhomogeneous temporal noise, preferably spatially homogenous or inhomogeneous temporal noise.
[Appendix 28] The process according to Appendix 21, wherein the non-interacting multi-level spins are qubits.
[Appendix 29] The process according to Appendix 21, further comprising assessing the power spectrum (including the frequency and the strength) of the noise, typically the temporal noise.
[Appendix 30] The process according to Appendix 29, further comprising tuning the bi-chromatic electromagnetic drive based on the power spectrum of the noise.
[Appendix 31] The process according to Appendix 29, further comprising determining Ω and/or Δ based on the power spectrum of the noise.
[Appendix 32] The quantum error correction system according to Appendix 1, wherein the quantum material comprises a single or an ensemble of non-interacting multi-level quantum spins.
[Appendix 33] The quantum error correction system according to Appendix 1, further comprising an assessment system configured to assess the temporal noise of the quantum material.
[Appendix 34] The error correction system according to Appendix 33, wherein the waveform of the bi-chromatic recovery drive generator is tuned based on the assessment of the temporal noise to correct error associated with the temporal noise of the quantum material.
[Appendix 35] The quantum error correction system according to Appendix 3, wherein s is greater than 4, preferably greater than 6 and more preferably greater than 10.
[Appendix 36] The quantum error correction system according to Appendix 6, wherein (Ω/Δ)² is equal to or nearly equal to 1/s in the limit when s>1, typically s>4, and more typically s>10, even more typically s>>1.
[Appendix 37] The quantum error correction system according to Appendix 1, wherein the quantum material is a temporal quantum system.
[Appendix 38] A device comprising the quantum error correction system according to Appendix 1.
[Appendix 39] A quantum computer comprising the quantum error correction system according to Appendix 1.
[Appendix 40] The quantum error correction system according to Appendix 1, wherein the spins are under the influence of temporal noise.
[Appendix 41] The quantum error correction system according to Appendix 4, wherein the Δ is the frequency detuning.
[Appendix 42] The quantum error correction system according to Appendix 1, wherein the spins are spins associated with color centers in diamond.
[Appendix 43] The quantum error correction system according to Appendix 1, wherein the spins are fluxonium qubits or blochnium qubits.
[Appendix 44] The quantum error correction system according to Appendix 3, wherein the energy levels are anharmonic.
[Appendix 45] The process according to Appendix 21, wherein the spins are spins associated with color centers in diamond, or are fluxonium qubits or blochnium qubits.
[Appendix 46] The process according to Appendix 22, wherein the energy levels are anharmonic.
[Appendix 47] The process according to Appendix 21, further comprising measuring the decay rate of coherent superposition of the states of the spins, typically using a Ramsey pulse sequence.
[Appendix 48] The process according to Appendix 47, further comprising tuning 92 and/or Δ based on the decay rate measured.
[Appendix 49] The quantum error correction system according to Appendix 4, wherein 0.5Δ/sqrt(s)<Ω<1.5Δ/sqrt(s), more preferably 0.9Δ/sqrt(s)<Ω<1.1Δ/sqrt(s), more preferably 0.99Δ/sqrt(s)<Ω<1.01Δ/sqrt(s), even more preferably 0.999Δ/sqrt(s)<Ω<1.001Δ/sqrt(s).
[Appendix 50] The process according to Appendix 24, wherein 0.5Δ/sqrt(s) <Ω<1.5Δ/sqrt(s), more preferably 0.9Δ/sqrt(s)<Ω1.1Δ/sqrt(s), more preferably 0.99Δ/sqrt(s)<Ω<1.01Δ/sqrt(s), even more preferably 0.999Δ/sqrt(s)<Ω<1.001Δ/sqrt(s).

### REFERENCES

The following references are hereby incorporated herein by reference in their entirety for all purposes:
[1] J. Preskill, Quantum computing in the NISQ era and beyond, Quantum 2, 1 (2018).
[2] C. Ryan-Anderson, J. G. Bohnet, K. Lee, D. Gresh, A. Hankin, J. P. Gaebler, D. Francois, A. Chernoguzov, D. Lucchetti, N. C. Brown, T. M. Gatterman, S. K. Halit, K. Gilmore, J. A. Gerber, B. Neyenhuis, D. Hayes, and R. P. Stutz, Realization of Real-Time Fault-Tolerant Quantum Error Correction, Physical Review X 11, 41058 (2021).
[3] M. Gong, S. Wang, C. Zha, M. C. Chen, H. L. Huang, Y. Wu, Q. Zhu, Y. Zhao, S. Li, S. Guo, H. Qian, Y. Ye, F. Chen, C. Ying, J. Yu, D. Fan, D. Wu, H. Su, H. Deng, H. Rong, K. Zhang, S. Cao, J. Lin, Y. Xu, L. Sun, C. Guo, N. Li, F. Liang, V. M. Bastidas, K. Nemoto, W. J. Munro, Y. H. Huo, C. Y. Lu, C. Z. Peng, X. Zhu, and J. W. Pan, Quantum walks on a programmable two-dimensional 62-qubit superconducting processor, Science 372, 948 (2021).
[4] M. J. Biercuk, H. Uys, A. P. VanDevender, N. Shiga, W. M. Itano, and J. J. Bollinger, Optimized dynamical decoupling in a model quantum memory, Nature 458, 996 (2009).
[5] F. Bussi eres, N. Sangouard, M. Afzelius, H. De Riedmatten, C. Simon, and W. Tittel, Prospective applications of optical quantum memories, Journal of Modern Optics 60, 1519 (2013).
[6] K. Heshami, C. Santori, B. Khanaliloo, C. Healey, V. M. Acosta, P. E. Barclay, and C. Simon, Raman quantum memory based on an ensemble of nitrogen-vacancy centers coupled to a microcavity, Physical Review A-Atomic, Molecular, and Optical Physics 89, 1 (2014).
[7] C. Grezes, Y. Kubo, B. Julsgaard, T. Umeda, J. Isoya, H. Sumiya, H. Abe, S. Onoda, T. Ohshima, K. Nakamura, I. Diniz, A. Auffeves, V. Jacques, J. F. Roch, D. Vion, D. Esteve, K. Moelmer, and P. Bertet, Towards a spin-ensemble quantum memory for superconducting qubits, Comptes Rendus Physique 17, 693 (2016).
[8] W. J. Munro, K. Azuma, K. Tamaki, and K. Nemoto, Inside Quantum Repeaters, IEEE Journal of Selected Topics in Quantum Electronics 21, 78 (2015).
[9] J. F. Barry, J. M. Schloss, E. Bauch, M. J. Turner, C. A. Hart, L. M. Pham, and R. L. Walsworth, Sensitivity optimization for NV-diamond magnetometry, Reviews of Modern Physics 92, 15004 (2020).
[10] S. Pezzagna and J. Meijer, Quantum computer based on color centers in diamond, Applied Physics Reviews 8, 10.1063/5.0007444 (2021).
[11] E. L. Hahn, Spin echoes, Physical Review 80, 580 (1950).
[12] D. A. Lidar, I. L. Chuang, and K. B. Whaley, Decoherence-free subspaces for quantum computation, Physical Review Letters 81, 2594 (1998).
[13] A. F. L. Poulsen, J. D. Clement, J. L. Webb, R. H. Jensen, K. Berg-Sorensen, A. Huck, and U. L. Andersen, Optimal control of a nitrogen-vacancy spin ensemble in diamond for sensing in the pulsed domain, 1 (2021).
[14] F. H. Koppens, K. C. Nowack, and L. M. Vandersypen, Spin echo of a single electron spin in a quantum dot, Physical Review Letters 100, 1 (2008).
[15] G. de Lange, Z. H. Wang, D. Rist e, V. V. Dobrovitski, and R. Hanson, Universal Dynamical Decoupling of a Single Solid-State Spin from a Spin Bath, Science 330, 60 (2010).
[16] N. Bar-Gill, L. Pham, A. Jarmola, D. Budker, and R. Walsworth, Solid-state electronic spin coherence time approaching one second, Nature Communications 4, 1743 (2013).
[17] L. Viola and S. Lloyd, Dynamical suppression of decoherence in two-state quantum systems, Physical Review A-Atomic, Molecular, and Optical Physics 58, 2733 (1998).
[18] P. Facchi, D. A. Lidar, and S. Pascazio, Unification of dynamical decoupling and the quantum Zeno effect, Physical Review A-Atomic, Molecular, and Optical Physics 69, 1 (2004).
[19] F. F. Fanchini, J. E. Hornos, and R. D. Napolitano, Continuously decoupling single-qubit operations from a perturbing thermal bath of scalar bosons, Physical Review A-Atomic, Molecular, and Optical Physics 75, 1 (2007).
[20] J. M. Cai, B. Naydenov, R. Pfeiffer, L. P. McGuinness, K. D. Jahnke, F. Jelezko, M. B. Plenio, and A. Retzker, Robust dynamical decoupling with concatenated continuous driving, New Journal of Physics 14, 10.1088/1367-2630/14/11/113023 (2012).
[21] A. Stark, N. Aharon, T. Unden, D. Louzon, A. Huck, A. Retzker, U. L. Andersen, and F. Jelezko, Narrow-bandwidth sensing of high-frequency fields with continuous dynamical decoupling, Nature Communications 8, 8 (2017).
[22] G. Wang, Y. X. Liu, and P. Cappellaro, Coherence protection and decay mechanism in qubit ensembles under concatenated continuous driving, New Journal of Physics 22, 10.1088/1367-2630/abd2c5 (2020).
[23] D. A. Golter, T. K. Baldwin, and H. Wang, Protecting a Solid-State Spin from Decoherence Using Dressed Spin States, Physical Review Letters 113, 1 (2014).
[24] A. Stark, N. Aharon, A. Huck, H. A. E1-Ella, A. Retzker, F. Jelezko, and U. L. Andersen, Clock transition by continuous dynamical decoupling of a three-level system, Scientific Reports 8, 1 (2018).
[25] G. T. Genov, N. Aharon, F. Jelezko, and A. Retzker, Mixed dynamical decoupling, Quantum Science and Technology 4, 10.1088/2058-9565/ab2afd (2019).
[26] C. Cohen-Tannoudji, F. Hoffbeck, and S. Reynaud, Compensating Doppler broadening with light-shifts, Optics Communications 27, 71 (1978).
[27] D. D. Yavuz, N. R. Brewer, J. A. Miles, and Z. J. Simmons, Suppression of inhomogeneous broadening using the ac Stark shift, Physical Review A 88, 063836 (2013).
[28] N. Aharon, I. Cohen, F. Jelezko, and A. Retzker, Fully robust qubit in atomic and molecular three-level systems, New Journal of Physics 18, 10.1088/1367-2630/aa4fd3 (2016).
[29] R. Finkelstein, O. Lahad, I. Cohen, O. Davidson, S. Kiriati, E. Poem, and O. Firstenberg, Continuous Protection of a Collective State from Inhomogeneous Dephasing, Physical Review X 11, 11008 (2021).
[30] N. Lambert, Y. Matsuzaki, K. Kakuyanagi, N. Ishida, S. Saito, and F. Nori, Superradiance with an ensemble of superconducting flux qubits, Physical Review B 94, 1 (2016).
[31] J. J. Burnett, A. Bengtsson, M. Scigliuzzo, D. Niepce, M. Kudra, P. Delsing, and J. Bylander, Decoherence benchmarking of superconducting qubits, npj Quantum Information 5, 1 (2019).
[32] D. Niepce, J. J. Burnett, M. Kudra, J. H. Cole, and J. Bylander, Stability of superconducting resonators: Motional narrowing and the role of Landau-Zener driving of two-level defects, Science Advances 7, 1 (2021).
[33] J. Li, M. P. Silveri, K. S. Kumar, J. M. Pirkkalainen, A. Vepsäläinen, W. C. Chien, J. Tuorila, M. A. Sillanpää, P. J. Hakonen, E. V. Thuneberg, and G. S. Paraoanu, Motional averaging in a superconducting qubit, Nature Communications 4, 1 (2013).
[34] G. Uhlenbeck and L. Ornstein, On the Theory of the Brownian Motion, Physical Review 36, 823 (1930).
[35] G. S. Uhrig, Keeping a quantum bit alive by optimized π-pulse sequences, Physical Review Letters 98, 7 (2007).
[36] M. A. Ali Ahmed, G. A. 'Alvarez, and D. Suter, Robustness of dynamical decoupling sequences, Physical Review A-Atomic, Molecular, and Optical Physics 87, 10.1103/PhysRevA.87.042309 (2013).
[37] R. Hanson, V. V. Dobrovitski, A. E. Feiguin, O. Gywat, and D. D. Awschalom, Coherent Dynamics of a Single Spin Interacting with an Adjustable Spin Bath, Science 320, 352 (2008).
[38] O. Lahad, R. Finkelstein, O. Davidson, O. Michel, E. Poem, and O. Firstenberg, Recovering the homogeneous absorption of inhomogeneous media, Physical Review Letters 123, 173203 (2019).
[39] R. Finkelstein, O. Lahad, O. Michel, O. Davidson, E. Poem, and O. Firstenberg, Power narrowing: Counteracting Doppler broadening in two-color transitions, New Journal of Physics 21, 10.1088/1367-2630/ab4624 (2019).
[40] M. W. Doherty, N. B. Manson, P. Delaney, F. Jelezko, J. Wrachtrup, and L. C. Hollenberg, The nitrogen-vacancy colour centre in diamond, Physics Reports 528, 1 (2013).
[41] M. W. Doherty, F. Dolde, H. Fedder, F. Jelezko, J. Wrachtrup, N. B. Manson, and L. C. Hollenberg, Theory of the ground-state spin of the NV-center in diamond, Physical Review B-Condensed Matter and Materials Physics 85, 10.1103/PhysRevB.85.205203 (2012).
[42] M. A. Nielsen and I. L. Chuang, Quantum Computation and Quantum Information (Cambridge University Press, 2010).
[43] C. E. Bradley, J. Randall, M. H. Abobeih, R. C. Berrevoets, M. J. Degen, M. A. Bakker, M. Markham, D. J. Twitchen, and T. H. Taminiau, A Ten-Qubit Solid-State Spin Register with Quantum Memory up to One Minute, Physical Review X 9, 031045 (2019).
[44] F. Quijandría and J. Twamley, Autonomous coherence protection of a two-level system in a fluctuating environment, arXiv: 2302.03827 (2023).
[45] P. C. Maurer, G. Kucsko, C. Latta, L. Jiang, N. Y. Yao, S. D. Bennett, F. Pastawski, D. Hunger, N. Chisholm, M. Markham, D. J. Twitchen, J. I. Cirac, and M. D. Lukin, Room-Temperature Quantum Bit Memory Exceeding One Second, Science 336, 1283 (2012).
[46] B. Smeltzer, L. Childress, and A. Gali, 13 C hyperfine interactions in the nitrogen-vacancy centre in diamond, New Journal of Physics 13, 025021 (2011).
[47] A. Schweiger and G. Jeschke, Annals of emergency medicine, Vol. 40 (Ocford University Press, 2001).
[48] H. Zhou, J. Choi, S. Choi, R. Landig, A. M. Douglas, J. Isoya, F. Jelezko, S., H. Sumiya, P. Cappellaro, H. S. Knowles, H. Park, and M. D. Lukin, Quantum Metrology with Strongly Interacting Spin Systems, Physical Review X 10, 31003 (2020).
[49] D. T. Gillespie, Exact numerical simulation of the Ornstein-Uhlenbeck process and its integral, Physical Review E-Statistical Physics, Plasmas, Fluids, and Related Interdisciplinary Topics 54, 2084 (1996).
[50] C. Bradley, J. Randall, M. Abobeih, R. Berrevoets, M. Degen, M. Bakker, M. Markham, D. Twitchen, and T. Taminiau, Supplemental Material: A 10-qubit solid-state spin register with quantum memory up to one minute, Physical Review X 9, 031045 [Supplemental] (2019).
[51] J. R. Johansson, P. D. Nation, and F. Nori, QuTiP 2: A Python framework for the dynamics of open quantum systems, Computer Physics Communications 184, 1234 (2013).
[52] W. Beatrez, O. Janes, A. Akkiraju, A. Pillai, A. Oddo, P. Reshetikhin, E. Druga, M. McAllister, M. Elo, B. Gilbert, D. Suter, and A. Ajoy, Floquet Prethermalization with Lifetime Exceeding 90 s in a Bulk Hyperpolarized Solid, Physical Review Letters 127, 170603 (2021).
[53] B. Pingault, D.-D. Jarausch, C. Hepp, L. Klintberg, J. N. Becker, M. Markham, C. Becher, and M. Atat282 üre, Coherent control of the silicon-vacancy spin in diamond, Nature Communications 8, 15579 (2017).
[54] H. H. Vallabhapurapu, C. Adambukulam, A. Saraiva, and A. Laucht, Indirect control of the 29 SiV-nuclear spin in diamond, Physical Review B 105, 205435 (2022).
[55] B. E. Kane, A silicon-based nuclear spin quantum computer, Nature 393, 133 (1998).
[56] G. Wolfowicz, P.-A. Mortemousque, R. Guichard, S. Simmons, M. L. W. Thewalt, K. M. Itoh, and J. J. L. Morton, 29 Si nuclear spins as a resource for donor spin qubits in silicon, New Journal of Physics 18, 023021 (2016).
[57] B. Hensen, W. Wei Huang, C. H. Yang, K. Wai Chan, J. Yoneda, T. Tanttu, F. E. Hudson, A. Laucht, K. M. Itoh, T. D. Ladd, A. Morello, and A. S. Dzurak, A silicon quantum-dot coupled nuclear spin qubit, Nature Nanotechnology 15, 13 (2020).
[58] B. Tissot, M. Trupke, P. Koller, T. Astner, and G. Burkard, Nuclear spin quantum memory in silicon carbide, Physical Review Research 4, 033107 (2022).

1. A quantum error correction system comprising:
a quantum material; and
a bi-chromatic recovery drive generator in communication with the quantum material,
wherein the bi-chromatic recovery drive generator sends a waveform to the quantum material.

2. The quantum error correction system according to claim 1, wherein the quantum material comprises a single or an ensemble of non-interacting multi-level spins.

3. The quantum error correction system according to claim 2, wherein each of the spins has at least three states |1>, |2> and |3> associated with respective energy levels E1, E2, and E3, wherein E1<E2, and E2<E3, and wherein the spins undergo energy shifts due to noise such that when state |2> of one of the spins undergoes an energy shift of −δ, state |3> of the same spin undergoes an energy shift of −sδ, wherein s is real, and s>0.

4. The quantum error correction system according to claim 3, wherein the waveform comprises two tones of continuous electromagnetic fields of identical or nearly identical amplitude Ω, having frequencies of ω+Δ and ω−Δ, wherein w corresponds to the energy separation between states |2> and |3> and wherein Δ>0.

5. The quantum error correction system according to claim 4, wherein the two tones of continuous electromagnetic fields are in phase or nearly in phase.

6. The quantum error correction system according to claim 4, wherein (Ω/Δ)² is equal to or nearly equal to 1/s in the limit when s>1, typically s>4, and more typically s>10.

7. The quantum error correction system according to claim 3, wherein the noise is either static spatially inhomogeneous noise, or spatially homogenous or inhomogeneous temporal noise.

8. The quantum error correction system according to claim 1, wherein the waveform corrects for static noise, temporal noise, or phase noise.

9. The quantum error correction system according to claim 2, wherein the spins are qubits.

10. The quantum error correction system according to claim 9, wherein the waveform converts a dirty qubit into a clean qubit.

11. The quantum error correction system according to claim 1, wherein the waveform is an off-resonant continuous wave driving in a multi-level structure.

12. The quantum error correction system according to claim 2, wherein the spins are nuclear spins coupled to nitrogen vacancy spins in diamond.

13. The quantum error correction system according to claim 3, wherein the energy levels are anharmonic.

14. A process for quantum error correction, comprising sending a bi-chromatic electromagnetic drive to a quantum system comprising an ensemble of non-interacting multi-level spins.

15. The process according to claim 14, further comprising measuring the decay rate of coherent superposition of the states of the spins, typically using a Ramsey pulse sequence.
